(19) United States
(12) Patent Application Publication
(10) Pub. No.: US 2021/0080846 A1
(43) Pub. Date: Mar. 18, 2021

(54) TONER

(71) Applicant: CANON KABUSHIKI KAISHA, Tokyo (JP)

(72) Inventors: Takuya Mizuguchi, Suntou-gun (JP); Yoshitaka Suzumura, Mishima-shi (JP); Hiroyuki Tomono, Numazu-shi (JP); Osamu Matsushita, Kawasaki-shi (JP); Shuntaro Watanabe, Hadano-shi (JP); Hiroki Akiyama, Suntou-gun (JP); Hiroki Kagawa, Mishima-shi (JP)

(21) Appl. No.: 17/012,889

(22) Filed: Sep. 4, 2020

(30) Foreign Application Priority Data
Sep. 13, 2019 (JP) 2019-166952

(51) Int. Cl. G03G 9/087

(52) U.S. Cl. CPC G03G 9/08755; G03G 9/08711

(57) ABSTRACT

A toner comprising a toner particle including a binder resin, wherein in a temperature T (° C.)-storage elastic modulus G′ (Pa) curve obtained by measuring the toner with a rheometer, a storage elastic modulus G′ (80° C.) at 80° C. is from 2.0×10³ Pa to 2.0×10⁵ Pa; and a local minimum value of a change amount (dG′/dT) of a storage elastic modulus G′ in a range of 60° C. to 80° C. with respect to a temperature T is −1.0×10⁶ or less, and when the temperature of the toner is raised, where a projected area of the toner at 80° C. is S₁ (μm²), a radius of the projected area of the toner at 80° C. is R₁ (μm), and a projected area of the toner at 120° C. is S₂ (μm²), the S₁, R₁ and S₂ satisfy a following formula (1):

S₂/S₁×1/R₁≤0.22. (1)

### BACKGROUND OF THE INVENTION

### Field of the Invention

The present invention relates to a toner used in an image forming method for developing an electrophotographic image or an electrostatic charge image.

### Description of the Related Art

Energy saving is in high demand for image forming apparatuses that use electrophotography, hence low-temperature fixability of toners needs to be improved. Generally, low-temperature fixability depends on the viscosity of toners, and toners having a viscosity that rapidly decrease under the effect of heat during fixing are needed. However, toners satisfying such low-temperature fixability are unlikely to withstand external stress resulting from agitation in a developing device and temperature rise of a main body, and problems such as decrease in durability and decrease in storage stability caused by embedding of an external additive can easily occur.

Further, in recent years, in addition to energy saving, there is a strong demand for high-speed processing apparatuses. Where a solid image is outputted on the entire surface in a high-speed image forming apparatus, peaks and valleys on a paper surface cause a problem such as density unevenness resulting in a difference in toner melting degree. Such a phenomenon is likely to occur in a toner having a reduced viscosity, and it is extremely difficult to achieve both energy saving and high speed processing because of technical hurdles.

Japanese Patent Application Publication No. 2014-167602 describes a toner in which a storage elastic modulus G′ at a temperature from 80° C. to 140° C. is controlled in order to improve low-temperature fixability and offset resistance.

### SUMMARY OF THE INVENTION

However, it has been found that although the toner for which storage elastic modulus G′ is controlled, such as in the abovementioned literature, exhibits a certain effect on the low-temperature fixability of toner, it causes solid image density unevenness in a high-speed image forming apparatus. Therefore, there is room for improvement with respect to solid image density unevenness.

The present invention provides a toner that solves the above problems.

That is, provided is a toner that has satisfactory low-temperature fixability and can suppress solid image density unevenness even in a high-speed apparatus.

As a result of repeated studies, the present inventors have found that the above-described requirements can be satisfied with the following configuration, and have arrived at the present invention.

That is, the present invention relates to a toner comprising a toner particle including a binder resin, wherein

in a temperature T (° C.)-storage elastic modulus G′ (Pa) curve obtained at a temperature rise rate of 2.0° C./min by measuring the toner with a rotating plate rheometer,

(i) a storage elastic modulus G′ (80° C.) at 80° C. is from 2.0×10³ Pa to 2.0×10⁵ Pa; and

(ii) a local minimum value of a change amount (dG′/dT) of a storage elastic modulus G in a range of 60° C. to 80° C. with respect to a temperature T is −1.0×10⁶ or less, and

when the temperature of the toner is raised from 25° C. to 120° C. at a temperature rise rate of 10° C./min, where a projected area of the toner at 80° C. is S₁ (μm²), a radius of the projected area of the toner at 80° C. is R₁ (μm), and a projected area of the toner at 120° C. is S₂ (μm²),

the S₁, R₁ and S₂ satisfy a following formula (1):

S₂/S₁×1/R₁≤0.22. (1)

The present invention can provide a toner that has satisfactory low-temperature fixability and can suppress solid image density unevenness even in a high-speed apparatus.

Further features of the present invention will become apparent from the following description of exemplary embodiments.

### DESCRIPTION OF THE EMBODIMENTS

Unless otherwise specified, the description of “from XX to YY” or “XX to YY” indicating a numerical range means a numerical range including a lower limit and an upper limit which are endpoints.

When a numerical range is described in stages, the upper and lower limits of each numerical range can be combined arbitrarily.

To improve low-temperature fixability, it is necessary to quickly melt the toner in a very short time in which the toner passes through a fixing nip. Generally, controlling melting characteristics of a resin component in a toner is known as a method of rapidly melting the toner. In recent years, various methods for controlling the melting characteristics of resin components by a plasticizing effect have been studied using fixing aids (additives such as low-melting wax, crystalline resin, and the like).

Accordingly, where a toner added with a crystalline polyester was evaluated from the viewpoint of improving the low-temperature fixability, it was found that although a certain effect was produced on the low-temperature fixability, solid image density unevenness was generated under high-speed printing conditions assumed for the next-generation art. Therefore, even though the viscosity of the toner is reduced when the toner passes through the fixing nip, the toner does not wet-spread too much at the protruding portions of the paper, and it is necessary to study toners that make it possible to suppress solid image density unevenness in order to meet future demands for energy saving and high speed.

As a result of a study conducted to solve the problem of trade-off between the improvement of low-temperature fixability and the suppression of solid image density unevenness, the present inventors came up with an idea that the abovementioned problems can be solved by using a toner having the following characteristics.

That is, the present invention relates to a toner comprising a toner particle including a binder resin, wherein in a temperature T (° C.)-storage elastic modulus G′ (Pa) curve obtained at a temperature rise rate of 2.0° C./min by measuring the toner with a rotating plate rheometer,

(i) a storage elastic modulus G′ (80° C.) at 80° C. is from 2.0×10³ Pa to 2.0×10⁵ Pa; and

(ii) a local minimum value of a change amount (dG′/dT) of a storage elastic modulus G in a range of 60° C. to 80° C. with respect to a temperature T is −1.0×10⁶ or less, and

when the temperature of the toner is raised from 25° C. to 120° C. at a temperature rise rate of 10° C./min, where a projected area of the toner at 80° C. is S₁ (μm²), a radius of the projected area of the toner at 80° C. is R₁ (μm), and a projected area of the toner at 120° C. is S₂ (μm²), the S₁, R₁ and S₂ satisfy a following formula (1):

S₂/S₁×1/R₁≤0.22. (1)

The toner will be described below in detail.

In a temperature T (° C.)-storage elastic modulus G′ (Pa) curve obtained at a temperature rise rate of 2.0° C./min by measuring the toner with a rotating plate rheometer, a storage elastic modulus G′ (80° C.) at 80° C. needs to be from 2.0×10³ Pa to 2.0×10⁵ Pa.

Further, the storage elastic modulus G′ (80° C.) is preferably from 2.0×10³ Pa to 1.5×10⁵ Pa, and more preferably from 2.0×10³ Pa to 1.0×10⁵ Pa since satisfactory low-temperature fixability can be obtained.

Normally, there are innumerable irregularities on paper surface, and recesses tend to receive less heat and pressure than protrusions when passing through the fixing nip. Therefore, the toner in the recesses is likely to be insufficiently melted as compared with the toner at the protrusions, and fixing defects are likely to occur. As a result of intensive studies, the present inventors have found that the storage elastic modulus G′ (80° C.) of the toner at 80° C. corresponds to the melting degree of the toner in the recesses on the paper.

The storage elastic modulus G′ is an index representing elasticity of a polymer, that is, a reversible property against stress. The storage elastic modulus G′ of the toner represents the force that restores the original state when the toner is deformed by heat and pressure in the fixing nip portion. That is, the storage elastic modulus indicates whether a molecule forming the toner has a spring-like property, and a smaller modulus value indicates a softer toner and a better low-temperature fixability.

When the storage elastic modulus G′ (80° C.) of the toner is larger than 2.0×10⁵ Pa, the toner viscosity is not sufficiently reduced by the heat received in the fixing nip and the remaining heat received after passing through the fixing nip. As a result, the adhesive force between the medium and the toner and between the toner particles is lowered, and when the fixed image is rubbed, fixing defects such as peeling of the toner from the surface of the medium occur.

Further, where an image is outputted under high-speed printing conditions, fixing defects such as chipped or missing printed portions also appear when the media passes through the fixing nip. It is considered that this is because the time required for the toner on the medium to pass through the fixing nip is reduced due to the speedup of the machine.

A toner that has not been sufficiently melted while passing through the fixing nip strongly adheres to the fixing member side, which is the heat source, and the printed portion is offset. Since the printed portion is missed or chipped at the moment when the toner passes through the fixing nip, the presence or absence of such defects is determined only by the amount of heat received by the toner in the fixing nip. In other words, no effect is produced by the melting of the toner caused by remaining heat after passing through the fixing nip.

As a result of intensive studies conducted to prevent printed portions from being missed or chipped, the present inventors came up with an idea that the problem can be solved by adopting the following features.

In a temperature T (° C.)-storage elastic modulus G′ (Pa) curve obtained at a temperature rise rate of 2.0° C./min by measuring the toner with a rotating plate rheometer, a local minimum value of a change amount (dG′/dT) of a storage elastic modulus G in a range of 60° C. to 80° C. with respect to a temperature T is −1.0×10⁶ or less.

From the viewpoint of obtaining satisfactory low-temperature fixability, the local minimum value of the change amount (dG′/dT) is preferably −5.0×10⁶ or less. The lower limit is not particularly limited, but is preferably −1.0×10⁸ or more, and more preferably −5.0×10⁷ or more.

The change amount (dG′/dT) indicates the slope of the storage elastic modulus G′ with respect to the temperature T. In other words, a smaller value of the change amount means that the toner viscosity is likely to change more rapidly, and it can be said that chipping or missing of printed portions of the toner is more likely to be suppressed.

Where the local minimum value of the change amount (dG′/dT) of the storage elastic modulus G′ with respect to the temperature T is larger than −1.0×10⁶, the viscosity cannot be sufficiently reduced within a short time in which the toner passes through the fixing nip, and the printed portions are chipped or missed.

The storage elastic modulus G′ (80° C.) of the toner and the local minimum value of the change amount (dG′/dT) of the storage elastic modulus G′ of the toner with respect to the temperature T can be controlled by, for example, changing the composition of the resin component or the composition of the fixing aid in the toner and by changing the dispersibility of materials (fixing aid, colorant, and the like). In addition, the control can be also performed by adjusting the amount of the inorganic particles contained in the toner.

Further, in the temperature T (° C.)-storage elastic modulus G′ (Pa) curve, the storage elastic modulus G′ (120° C.) at 120° C. is preferably from 2.0×10³ Pa to 2.0×10⁴ Pa, and more preferably from 4.0×10³ Pa to 1.0×10⁴ Pa.

As mentioned above, protrusions on the paper surface tend to receive more heat when passing through the fixing nip than the recesses. Therefore, the toner on the protrusion is likely to be excessively melted as compared with the toner in the recess, and solid image density unevenness is likely to occur. As a result of intensive studies, the present inventors have found that the storage elastic modulus G′ (120° C.) of the toner at 120° C. corresponds to the melting degree at the protrusion on the paper.

By setting the storage elastic modulus G′ (120° C.) of the toner in the above range, it is possible to suppress the solid image density unevenness and obtain a toner with satisfactory hot offset resistance. The storage elastic modulus G′ (120° C.) can be controlled by, for example, changing the composition of the resin component or the composition of the fixing aid in the toner and by changing the dispersibility of materials (fixing aid, colorant, and the like). In addition, the control can be also performed by adjusting the amount of inorganic particles contained in the toner.

When the temperature of the toner is raised from 25° C. to 120° C. at a temperature rise rate of 10° C./min, where a projected area of the toner at 80° C. is S_{1 (μm}²), a radius of the projected area of the toner at 80° C. is R₁ (μm), and a projected area of the toner at 120° C. is S₂ (μm²), the S₁, R₁ and S₂ satisfy a following formula (1).

S₂/S₁×1/R₁≤0.22. (1)

By setting the relationship among S₁, S₂, and R₁ within the above range, it is possible to suppress the solid image density unevenness even during high-speed printing. The reason for this is considered hereinbelow.

As mentioned above, the main cause of solid image density unevenness is considered to be the toner melting unevenness due to unevenness of the media. In particular, in the case of commonly used paper, there is a variation of about 30 μm between the recesses and the protrusions on the paper surface.

Normally, the temperature of a fixing device is set so that the toner in the recess, which receives a small amount of heat in the fixing nip portion, can be fixed, so the toner in the protrusion receives an excessive amount of heat in the fixing nip portion. It has been found that in the case of a machine adapted to speed increase, the difference in the amount of heat received by the toner in the recess and the toner on the protrusion becomes larger, and there is a difference of about 40° C. in the reached temperature of the toner.

Therefore, in order to suppress solid image density unevenness also in a machine adapted to speed increase, it is required that the difference in the area where the toner wet-spreads on the paper be small even under different temperature conditions. As a result of intensive studies conducted to obtain such an effect, the inventors have found that it is important to set the wet-spreading parameter calculated from the formula (1) within the above range.

The ease with which a toner wet-spreads on a medium can be controlled by a combination of toner materials and a toner particle size. However, the toner particle size is often limited by the configuration of a main body and a cartridge CRG and in many cases cannot be freely selected. Therefore, attention was focused on controlling the ease with which a toner wet-spreads on a medium by a combination of toner materials.

Specifically, it was decided to take a product of 1/R₁ in order to remove the factor of toner particle size from the ease with which a toner wet-spreads on a medium. The reason therefor is described hereinbelow.

Where the toner is assumed to be spherical, the volume of the toner before fixing is proportional to the cube of the radius. Meanwhile, the projected area of the toner on the medium is proportional to the square of the radius. Assuming that the toner wet-spreads on the media to a certain thickness, the difference between the volume index and the area index needs to be taken into account.

Therefore, it is considered that the factor of the toner particle size can be removed by taking the product of 1/R₁ and a change ratio S₂/S₁ of the projected area of the toner at 80° C. and the projected area at 120° C.

Where S₂/S₁×1/R₁ is larger than 0.22, the area change of the toner on the protrusion with respect to the recess on the paper surface becomes large, resulting in solid image density unevenness. S₂/S₁×1/R₁ is preferably 0.20 or less. Meanwhile, the lower limit is not particularly limited, but it is preferably 0.12 or more, and more preferably 0.15 or more.

The value of S₂/S₁×1/R₁ can be controlled by, for example, using a binder resin described later. The control can also be performed by adjusting the dispersion diameter of the crystalline material (crystalline resin, wax, and the like), the melting point of the crystalline material, and the compatibility of the crystalline material with the binder resin.

Where an amount of an ethyl acetate-insoluble matter of the toner when the toner is extracted for 18 hours by Soxhlet extraction using ethyl acetate is α (% by mass), a is preferably from 25.0 mass % to 55.0 mass %, and more preferably from 30.0 mass % to 50.0 mass %.

Since ethyl acetate has an ester group and has a high polarity, it is possible to extract a linear component that also has an ester group and a high polarity.

Meanwhile, in the case where the molecules are strongly entangled with each other even if the component has a high polarity, or in the case of a non-polar component, the extraction hardly proceeds. That is, the crosslinked structure between a vinyl polymer segment and an amorphous polyester segment, the crosslinked structure in the amorphous polyester segment, and the like, which are described hereinbelow, are matters insoluble in ethyl acetate.

The linear component soluble in ethyl acetate plasticizes the resin in a high-temperature and high-humidity environment, so where the amount of ethyl acetate-insoluble matter in the binder resin satisfies the above range, the plasticization of the toner is suppressed and the durability is improved when the toner is used for a long time in a high-temperature and high-humidity environment.

The amount of ethyl acetate-insoluble matter can be adjusted by changing the monomer composition and production conditions of the binder resin and the toner production conditions.

Where an amount of a tetrahydrofuran-insoluble matter of the toner when the toner is extracted for 18 hours by Soxhlet extraction using tetrahydrofuran (THF) is β (% by mass), the 0 preferably satisfies a following formula (2), more preferably satisfies a following formula (2′), and even more preferably satisfies a following formula (2″).

5.0≤β≤30.0 (2)

5.0≤β≤20.0 (2′)

8.0≤β≤20.0. (2″)

Since THF has a furan ring and can elute not only a polar linear component but also a polar entangled component and even a non-polar linear component, most of the binder resin components can be eluted.

That is, the crosslinked structure in the amorphous polyester segment, which will be described hereinbelow, becomes a THF-insoluble matter. The THF-insoluble matter is hard to be deformed in a temperature range at the time of fixing, excessive deformation of the toner when the toner is melted can be suppresses, and the solid image density unevenness can be suppressed. Further, since the external additive can be prevented from embedding in the toner, the durability is improved.

The amount of the THF-insoluble matter can be adjusted by changing the monomer composition and production conditions of the binder resin, and the toner production conditions.

Further, the amount α (% by mass) of the ethyl acetate-insoluble matter and the amount (3 (% by mass) of the tetrahydrofuran-insoluble matter preferably satisfy a following formula (3), more preferably satisfy a following formula (3′), and even more preferably satisfy a following formula (3″).

10.0≤(α-β)≤40.0 (3)

15.0≤(α-β)≤33.0 (3′)

17.0≤(α-β)≤25.0. (3″)

As described above, the amount of ethyl acetate-insoluble matter may be influenced by, for example, the crosslinked structure between the vinyl polymer segment and the amorphous polyester segment, and the crosslinked structure in the amorphous polyester segment. Further, the amount of THF-insoluble matter may be influenced by the crosslinked structure in the amorphous polyester segment. That is, (α-β) in the formula (3) may be influenced by the crosslinked structure between the vinyl polymer segment and the amorphous polyester segment.

As will be described hereinbelow, the crosslinked structure between the vinyl polymer segment and the amorphous polyester segment has a short distance between crosslinking points and forms a dense mesh, so that tangling with other raw materials and material dispersibility in the toner can be improved. As a result, with the toner in which (α-β) satisfies the above range, the solid image density unevenness as well as fogging can be suppressed.

It is preferable that the toner include a tetrahydrofuran-insoluble matter when the toner is extracted by Soxhlet extraction using tetrahydrofuran for 18 hours. Further, a storage elastic modulus G′ (120° C.) at 120° C. measured at a temperature rise rate of 2.0° C./min by measuring the tetrahydrofuran-insoluble matter with a rotating plate rheometer is preferably from 1.0×10⁵ Pa to 1.0×10′ Pa, and more preferably from 2.0×10⁵ Pa to 5.0×10⁶ Pa.

When the storage elastic modulus G′ (120° C.) of the THF-insoluble matter satisfies the above range, the solid image density unevenness can be suppressed and a toner having satisfactory durability can be obtained.

Binder Resin

The binder resin is not particularly limited, and a known resin can be used. The binder resin preferably includes a hybrid resin having a vinyl polymer segment and an amorphous polyester segment. Where the binder resin includes a hybrid resin having an amorphous polyester segment having excellent melting properties and a vinyl polymer segment having excellent charging characteristic and a high softening point, excellent charging stability and low-temperature fixability are achieved while increasing the softening point of the binder resin. As a result, the low-temperature fixability and the stability of image density under a high-humidity environment are further enhanced.

The amount of the hybrid resin in the binder resin is preferably from 50% by mass to 100% by mass, more preferably from 80% by mass to 100% by mass, and even more preferably from 90% by mass to 100% by mass.

In the hybrid resin, the vinyl polymer segment and the amorphous polyester segment are preferably hybridized by a transesterification reaction. As a result, a crosslinked structure is formed between the vinyl polymer segment and the amorphous polyester segment, and it becomes easy to control the amount a (% by mass) of ethyl acetate-insoluble matter and the amount β (% by mass) of THF-insoluble matter.

The crosslinked structure between the vinyl polymer segment and the amorphous polyester segment has a short distance between crosslinking points and is likely to form comparatively small meshes, so that the storage elastic modulus G′ of the crosslinked segments can be increased. Therefore, the solid image density unevenness can be suppressed.

In the hybrid resin, the mass ratio of the amorphous polyester segment to the vinyl polymer segment (amorphous polyester segment: vinyl polymer segment) is preferably from 50:50 to 98:2, more preferably from 70:30 to 97:3, and even more preferably from 90:10 to 97:3.

That is, the amount of the amorphous polyester segment in the hybrid resin is preferably from 50% by mass to 98% by mass, more preferably from 70% by mass to 97% by mass, and even more preferably from 90% by mass to 97% by mass.

By setting the above range, stable low-temperature fixability is exhibited regardless of the environment while realizing the merits of hybrid resin. Further, the amount α (% by mass) of the ethyl acetate-insoluble matter and the amount β (% by mass) of the THF insoluble matter can be easily controlled, and the solid image density unevenness can be suppressed.

The following compounds may be mentioned as the monomers constituting the polyester resin or polyester part.

The alcohol component can be exemplified by the following dihydric alcohols:

ethylene glycol, propylene glycol, 1,3-butanediol, 1,4-butanediol, 2,3-butanediol, diethylene glycol, triethylene glycol, 1,5-pentanediol, 1,6-hexanediol, neopentyl glycol, 2-ethyl-1,3-hexanediol, hydrogenated bisphenol A, bisphenols given by the following formula (I) and their derivatives, and diols given by the following formula (II).

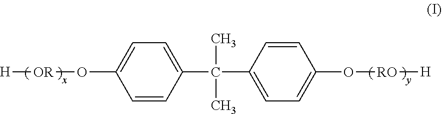

(In the formula, R represents an ethylene group or propylene group; x and y are each integers equal to or greater than 0; and the average value of x+y is at least 0 and not more than 10.)

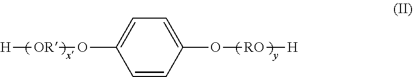

(In the formula, R′ is

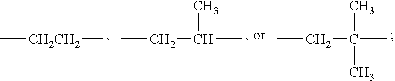

x′ and y′ are each integers equal to or greater than 0; and the average value of x′+y′ is from 0 to 10.)

The following dibasic carboxylic acids are examples of the acid component:

benzenedicarboxylic acids and anhydrides thereof, e.g., phthalic acid, terephthalic acid, isophthalic acid, and phthalic anhydride; alkyl dicarboxylic acids, e.g., succinic acid, adipic acid, sebacic acid, and azelaic acid, and their anhydrides; succinic acid substituted by an alkyl group having from 6 to 18 carbons or by an alkenyl group having from 6 to 18 carbons, and anhydrides thereof; and unsaturated dicarboxylic acids, e.g., fumaric acid, maleic acid, citraconic acid, and itaconic acid, and anhydrides thereof.

The polyester resin or polyester segment preferably includes a monomer unit derived from a polyhydric alcohol or a monomer unit derived from a polyvalent carboxylic acid. That is, the amorphous polyester segment preferably has a structure crosslinked with at least one selected from the group consisting of a trihydric or higher polyhydric alcohol and a trivalent or higher polyvalent carboxylic acids. As a result, a crosslinked structure is formed in the amorphous polyester segment, and it becomes easy to control the amount β (% by mass) of THF-insoluble matter.

The crosslinked structure has a long distance between crosslinking points and can easily form relatively large meshes, so that a three-dimensional network structure can be constructed in the entire binder resin. Therefore, the solid image density unevenness and the durability stability of the toner are improved.

Tribasic and higher basic polybasic carboxylic acids can be exemplified by 1,2,4-benzenetricarboxylic acid (trimellitic acid), 1,2,4-cyclohexanetricarboxylic acid, 1,2,4-naphthalenetricarboxylic acid, and pyromellitic acid and their anhydrides and lower alkyl esters.

Among the preceding, aromatic compounds, which are also stable to environmental fluctuations, are preferred, for example, 1,2,4-benzenetricarboxylic acid and its anhydrides.

The trihydric and higher hydric polyhydric alcohols can be exemplified by 1,2,3-propanetriol, trimethylolpropane, hexanetriol, and pentaerythritol.

The binder resin preferably includes a resin composition including a hybrid resin having a vinyl polymer segment and an amorphous polyester segment, and more preferably is a resin composition including a hybrid resin having a vinyl polymer segment and an amorphous polyester segment.

The resin composition preferably includes

(i) at least one of a structure in which a long-chain alkyl monoalcohol having an average value of a carbon number of from 27 to 50 is condensed at the terminal of an amorphous polyester segment and a structure in which a long-chain alkyl monocarboxylic acid having an average value of a carbon number of from 27 to 50 is condensed at the terminal of an amorphous polyester segment, and
(ii) an aliphatic hydrocarbon having an average value of a carbon number of from 27 to 50.

Where the binder resin includes the above resin composition, when a crystalline polyester is added, the crystallization rate of the crystalline polyester is improved, and a toner having good heat-resistant storage stability can be obtained.

The amount of the resin composition in the binder resin is preferably from 50% by mass to 100% by mass, more preferably from 80% by mass to 100% by mass, and even more preferably from 90% by mass to 100% by mass.

The structure in which a long-chain alkyl monoalcohol is condensed will be hereinbelow also referred to as an alcohol residue. The structure in which a long-chain alkyl monocarboxylic acid is condensed will be hereinbelow also referred to as a carboxylic acid residue. Moreover, these residues are also called long-chain alkyl components.

Here, a polyester resin having at least one residue of the alcohol residue of a long-chain alkyl monoalcohol and the carboxylic acid residue of a long-chain alkyl monocarboxylic acid as a terminal represents a resin in which these long-chain alkyl components have been incorporated by reacting with a polyester resin that is the main binder component.

Meanwhile, where the resin composition includes the aliphatic hydrocarbon having the above average carbon number, the resin composition also includes an unmodified component, for example, when a long-chain alkyl component has been alcohol-modified or acid-modified.

The resin composition means that it comprises a polyester resin in which a long-chain alkyl component is incorporated and an aliphatic hydrocarbon component (which is, for example, an unmodified product of the long-chain alkyl component).

The average value of a carbon number of a long-chain alkyl component is determined by the following method.

The distribution of the carbon number in the long-chain alkyl component is measured as follows by gas chromatography (GC). 10 mg of the sample is exactly weighed out and introduced into a sample vial. 10 g of exactly weighed hexane is added to this sample vial and the lid is put on followed by heating to a temperature of 150° C. on a hot plate and mixing.

After this, and in a state in which the long-chain alkyl component has not precipitated, this sample is injected into the injection port of a gas chromatograph and analysis is performed by the following measurement instrumentation and measurement conditions to obtain a chart in which the horizontal axis is the carbon number and the vertical axis is the signal strength.

Then, using the obtained chart, the percentage for the peak area for the component at each carbon number is calculated with respect to the total area of all the detected peaks and this is taken to be the percentage occurrence (area %) for the individual hydrocarbon compounds. A carbon number distribution chart is constructed plotting the carbon number on the horizontal axis and the percentage occurrence (area %) of the hydrocarbon compounds on the vertical axis. The average carbon number refers to the carbon number for the peak top in the chart for the distribution of the carbon number.

The measurement instrumentation and measurement conditions are as follows.

GC: 6890GC from Hewlett-Packard
column: ULTRA ALLOY-1 P/N: UA1-30m-0.5F (from Frontier Laboratories Ltd.)
carrier gas: He
oven: (1) hold 5 minutes at a temperature of 100° C., (2) ramp up to a temperature of 360° C. at 30° C./minute, (3) hold for 60 minutes at a temperature of 360° C.
injection port: temperature=300° C.
initial pressure: 10.523 psi
split ratio: 50:1
column flow rate: 1 mL/min

Further, the total content ratio of an aliphatic hydrocarbon having an average value of a carbon number of from 27 to 50, the structure (alcohol residue) in which a long-chain alkyl monoalcohol having an average value of a carbon number of from 27 to 50 are condensed and the structure (carboxylic acid residue) in which a long-chain alkyl monocarboxylic acid having an average value of a carbon number of from 27 to 50 is condensed in the resin composition is preferably from 2.5% by mass to 10.0% by mass, and more preferably from 3.5% by mass to 7.5% by mass.

By setting the content ratio of the components derived from long-chain alkyls within the above range, the crystallization rate of the crystalline polyester can be easily controlled, and a toner with good storage stability can be obtained.

Further, in the temperature-endothermic quantity curve of the resin composition obtained by differential scanning calorimetry (DSC), a peak top temperature of the endothermic peak of the resin composition is preferably from 60.0° C. to 90.0° C.

The endothermic quantity (AH) of the endothermic peak is preferably from 0.10 J/g to 1.90 J/g, and more preferably from 0.20 J/g to 1.00 J/g.

In order to achieve both the low-temperature fixability of the toner and the suppression of solid image density unevenness, it is preferable to uniformly disperse the crystalline polyester in the toner. For that purpose, it is preferable that the components derived from the long-chain alkyls be uniformly dispersed in the binder resin, and it is preferable that the amount of the components that are not bonded to the polyester resin components and are freed, that is, the amount of the unmodified aliphatic hydrocarbon be optimized.

The endothermic peak of this unmodified aliphatic hydrocarbon appears in the temperature-endothermic quantity curve obtained by differential scanning calorimetry (DSC). Where the endothermic quantity ΔH observed by DSC is within the above range, it indicates that the amount of the free long-chain alkyl component is small, that is, this component is incorporated in the polyester resin (main binder).

Therefore, the present inventors believe that by optimizing the endothermic quantity (ΔH) of this endothermic peak, the component derived from a long-chain alkyl can be easily dispersed uniformly in the resin composition.

The peak top temperature and endothermic quantity (ΔH) of the endothermic peak are measured in the present invention by the following method.

The peak top temperature and endothermic peak quantity of the endothermic peak by differential scanning calorimetric measurement (DSC) are measured based on ASTM D 3418-82 using a “Q2000” differential scanning calorimeter (TA Instruments). Temperature correction in the instrument detection section is performed using the melting points of indium and zinc, and the amount of heat is corrected using the heat of fusion of indium.

Specifically, approximately 5 mg of the measurement sample is accurately weighed out and this is introduced into an aluminum pan and the measurement is run at normal temperature and normal humidity at a ramp rate of 10° C./minute in the measurement temperature range between 30° C. and 200° C. using an empty aluminum pan as reference. The measurement is carried out by initially raising the temperature to 200° C., then cooling to 30° C., and then reheating. The temperature at the peak top of the maximum endothermic peak in the 30° C. to 200° C. temperature range in the DSC curve (temperature-endothermic quantity curve) obtained in this ramp up process is determined. In addition, the endothermic quantity ΔH of the endothermic peak is the integration value for the endothermic peak.

Methods for controlling the amount of free long-chain alkyl component, i.e., the endothermic peak quantity in DSC, can be exemplified by the method of increasing the alcohol modification rate or acid modification rate of the aliphatic hydrocarbon.

Thus, with regard to the alcohol- or acid-modified long-chain alkyl component, it reacts with the polyester resin during the polymerization reaction and is thereby inserted into the polyester resin and as a result an endothermic peak does not appear for it in DSC measurements. The unmodified aliphatic hydrocarbon component, on the other hand, does not have a site that reacts with the polyester resin and as a consequence is present in a free state in the polyester resin and increases the endothermic quantity in DSC.

As noted above, the long-chain alkyl monoalcohol having an average of 27 to 50 carbons and the long-chain alkyl monocarboxylic acid having an average of 27 to 50 carbons that are used in the present invention are obtained industrially by the alcohol- or acid-modification of a starting aliphatic hydrocarbon.

This aliphatic hydrocarbon encompasses saturated hydrocarbons and unsaturated hydrocarbons and can be exemplified by alkanes, alkenes, and alkynes and by cyclic hydrocarbons such as cyclohexane, but saturated hydrocarbons (alkanes) are preferred.

For example, for the alcohol-modified product, it is known that an aliphatic hydrocarbon having 27 to 50 carbons can be converted to the alcohol by liquid-phase oxidation with a molecular oxygen-containing gas in the presence of a catalyst such as boric acid, boric anhydride, or metaboric acid. The amount of addition for the catalyst used is preferably from 0.01 mol to 0.5 mol per 1 mol of the starting saturated hydrocarbon.

A broad range of molecular oxygen-containing gases can be used for the molecular oxygen-containing gas that is injected into the reaction system, for example, oxygen, air, or these diluted with an inert gas; however, an oxygen concentration of from 3% to 20% is preferred. The reaction temperature is preferably from 100° C. to 200° C.

The endothermic quantity determined by DSC can be controlled by optimizing the reaction conditions and removing the unmodified aliphatic hydrocarbon component by carrying out a purification operation after the modification reaction. The modification ratio of the aliphatic hydrocarbon component is preferably 85% or more, and more preferably 90% or more. Meanwhile, the upper limit is preferably 99% or less.

Further, the resin composition preferably includes a structure in which a long-chain alkyl monoalcohol having an average value of a carbon number of from 27 to 50 is condensed at the terminal, and an aliphatic hydrocarbon having an average value of a carbon number of from 27 to 50. The long-chain alkyl monoalcohol preferably includes a secondary alcohol, and more preferably includes a secondary alcohol as a main component. Having a secondary alcohol as a main component means that 50% by mass or more of the long-chain alkyl monoalcohol is a secondary alcohol.

By using a secondary alcohol as the main component of the long-chain alkyl monoalcohol, the long-chain alkyl component can easily assume a folded structure. As a result, steric hindrance or the like is suppressed, the long-chain alkyl component is likely to be present in the resin composition more uniformly, and storage stability is further improved.

The vinyl polymer segment contained in the hybrid resin preferably includes a monomer unit derived from styrene and a monomer unit derived from an acrylic acid ester and/or a methacrylic acid ester, and the total content ratio of the monomer units derived from the acrylic acid ester and methacrylic acid ester is preferably from 50 mol % to 98 mol %, more preferably from 70 mol % to 97 mol %, and even more preferably from 85 mol % to 97 mol % in all the monomer units forming the vinyl polymer segment.

As a result, the density of the crosslinked structure between the vinyl polymer segment and the amorphous polyester segment can be adjusted, which facilitates control of the amount α (% by mass) of the ethyl acetate-insoluble matter and the amount β (% by mass) of the THF-insoluble matter. Therefore, solid image density unevenness can be suppressed.

The following compounds are examples of the vinylic monomer for forming the vinyl polymer segment:

styrene and its derivatives such as styrene, o-methylstyrene, m-methylstyrene, p-methylstyrene, p-methoxystyrene, p-phenyl styrene, p-chlorostyrene, 3,4-dichlorostyrene, p-ethylstyrene, 2,4-dimethyl styrene, p-n-butyl styrene, p-tert-butylstyrene, p-n-hexylstyrene, p-n-octylstyrene, p-n-nonylstyrene, p-n-decylstyrene, and p-n-dodecylstyrene; unsaturated monoolefins such as ethylene, propylene, butylene, and isobutylene; unsaturated polyenes such as butadiene and isoprene; vinyl halides such as vinyl chloride, vinylidene chloride, vinyl bromide, and vinyl fluoride; vinyl esters such as vinyl acetate, vinyl propionate, and vinyl benzoate; methacrylate esters such as methyl methacrylate, ethyl methacrylate, propyl methacrylate, n-butyl methacrylate, isobutyl methacrylate, n-octyl methacrylate, dodecyl methacrylate, 2-ethylhexyl methacrylate, stearyl methacrylate, phenyl methacrylate, dimethylaminoethyl methacrylate, and diethylaminoethyl methacrylate; acrylate esters such as methyl acrylate, ethyl acrylate, n-butyl acrylate, isobutyl acrylate, propyl acrylate, n-octyl acrylate, dodecyl acrylate, 2-ethylhexyl acrylate, stearyl acrylate, 2-chloroethyl acrylate, and phenyl acrylate; vinyl ethers such as vinyl methyl ether, vinyl ethyl ether, and vinyl isobutyl ether; vinyl ketones such as vinyl methyl ketone, vinyl hexyl ketone, and methyl isopropenyl ketone; N-vinyl compounds such as N-vinylpyrrole, N-vinylcarbazole, N-vinylindole, and N-vinylpyrrolidone; vinylnaphthalene; and derivatives of acrylic acid or methacrylic acid such as acrylonitrile, methacrylonitrile, and acrylamide.

The following are additional examples: unsaturated dibasic acids such as maleic acid, citraconic acid, itaconic acid, alkenylsuccinic acid, fumaric acid, and mesaconic acid; unsaturated dibasic acid anhydrides such as maleic anhydride, citraconic anhydride, itaconic anhydride, and alkenylsuccinic anhydride; the half esters of unsaturated dibasic acids, such as the methyl half ester of maleic acid, ethyl half ester of maleic acid, butyl half ester of maleic acid, methyl half ester of citraconic acid, ethyl half ester of citraconic acid, butyl half ester of citraconic acid, methyl half ester of itaconic acid, methyl half ester of alkenylsuccinic acid, methyl half ester of fumaric acid, and methyl half ester of mesaconic acid; esters of unsaturated dibasic acids, such as dimethyl maleate and dimethyl fumarate; α,β-unsaturated acids such as acrylic acid, methacrylic acid, crotonic acid, and cinnamic acid; the anhydrides of α,β-unsaturated acids, such as crotonic anhydride and cinnamic anhydride; anhydrides between an α,β-unsaturated acid and a lower fatty acid; and carboxyl group-containing monomers such as alkenylmalonic acid, alkenylglutaric acid, and alkenyladipic acid and their anhydrides and monoesters.

Additional examples are esters of acrylic acid or methacrylic acid, such as 2-hydroxyethyl acrylate, 2-hydroxyethyl methacrylate, and 2-hydroxypropyl methacrylate, and hydroxy group-containing monomers such as 4-(1-hydroxy-1-methylbutyl)styrene and 4-(1-hydroxy-1-methylhexyl)styrene.

The vinyl polymer segment preferably has a structure in which at least one selected from the group consisting of an acrylic acid ester and a methacrylic acid ester is polymerized. The vinyl polymer segment preferably has a structure in which at least one selected from the group consisting of acrylic acid ester and methacrylic acid ester is polymerized, and a structure in which styrene is polymerized.

The total amount of the structure in which at least one selected from the group consisting of an acrylic acid ester and a methacrylic acid ester in the vinyl polymer segment is polymerized is preferably from 50% by mass to 98% by mass, and more preferably from 70% by mass to 98% by mass.

The binder resin preferably has both a crosslinked structure between the vinyl polymer segment and the amorphous polyester segment and a crosslinked structure in the amorphous polyester segment. This makes it easier to control the storage elastic modulus G′ and the toner wet-spreading index within the above ranges.

Crystalline Polyester Resin

The toner particle preferably includes a crystalline polyester resin.

Here, the crystalline polyester is defined as a polyester resin having a clear endothermic peak when measured by a differential scanning calorimeter (DSC).

The crystalline polyester resin will be described hereinbelow.

A known crystalline polyester resin can be used. For example, a polycondensation product of an aliphatic dicarboxylic acid and an aliphatic diol may be mentioned.

The crystalline polyester resin is preferably a polycondensation product of aliphatic dicarboxylic acids and aliphatic diols, and at least one selected from the group consisting of aliphatic monocarboxylic acids and aliphatic monoalcohols. The crystalline polyester resin is more preferably a polycondensation product of an aliphatic dicarboxylic acid and an aliphatic diol, and an aliphatic monocarboxylic acid.

Examples of the aliphatic dicarboxylic acid include an aliphatic dicarboxylic acid having from 2 to 20 carbon atoms. Examples thereof include oxalic acid, malonic acid, succinic acid, glutaric acid, adipic acid, pimelic acid, suberic acid, azelaic acid, sebacic acid, dodecanedioic acid, hexadecanedicarboxylic acid, octadecanedicarboxylic acid, and the like.

Examples of the aliphatic diol include an aliphatic diol having from 2 to 20 carbon atoms. Examples thereof include ethylene glycol, diethylene glycol, triethylene glycol, 1,2-propylene glycol, 1,3-propylene glycol, dipropylene glycol, trimethylene glycol, neopentyl glycol, 1,4-butanediol, 1,6-hexanediol, 1,7-heptanediol, 1,8-octanediol, 1,9-nonanediol, 1,10-decanediol, 1,11-undecanediol, 1,12-dodecanediol, 1,16-hexadecanediol, 1,18-octadecanediol, and the like.

Examples of the aliphatic monocarboxylic acid include an aliphatic monocarboxylic acid having from 6 to 20 carbon atoms. Examples thereof include hexanoic acid, heptanoic acid, octanoic acid, nonanoic acid, decanoic acid (capric acid), dodecanoic acid (lauric acid), tetradecanoic acid (myristic acid), hexadecanoic acid (palmitic acid), octadecanoic acid (stearic acid), eicosanic acid (arachidic acid), docosanoic acid (behenic acid), tetracosanoic acid (lignoselic acid), and the like.

Examples of the aliphatic monoalcohol include an aliphatic monoalcohol having from 6 to 20 carbon atoms. Examples thereof include capryl alcohol, undecanol, lauryl alcohol, tridecanol, myristyl alcohol, pentadecanol, palmityl alcohol, margaryl alcohol, stearyl alcohol, nonadecanol, arachidyl alcohol, and the like.

The crystalline polyester resin is preferably a polycondensation product of an alcohol component including an aliphatic diol and an acid component including an aliphatic dicarboxylic acid. Where the carbon number of the aliphatic diol is C1 and the carbon number of the aliphatic dicarboxylic acid is C2, the sum of C1 and C2 is preferably from 10 to 16, and more preferably from 12 to 16.

Where multiple aliphatic diols and/or aliphatic dicarboxylic acids are used, the carbon number of each is the average value by mass fraction.

The sum of C1 and C2 being from 10 to 16 means that the total number of carbon atoms of the aliphatic diol and the aliphatic dicarboxylic acid constituting the crystalline polyester resin is relatively small.

By reducing the sum of C1 and C2 to the above range, the number of ester groups contained in the crystalline polyester resin increases. The increase in the number of ester groups increases the polarity of the crystalline polyester resin. As a result, the rate of plasticizing the binder resin becomes very high, and the effect of the present invention is easily exhibited.

The crystalline polyester resin is a polycondensation product of an alcohol component including an aliphatic diol and an acid component including an aliphatic dicarboxylic acid, and preferably has at least one of a structure in which an aliphatic monocarboxylic acid is condensed on the terminal and a structure in which an aliphatic monoalcohol is condensed on the terminal.

The carbon number C3 of at least one of the structure in which the aliphatic monocarboxylic acid is condensed and the structure in which the aliphatic monoalcohol is condensed is preferably from 6 to 14.

The melting point of the crystalline polyester resin is preferably from 65° C. to 100° C. The melting point is determined by the combination of the carboxylic acid component and the alcohol component used, and may be selected, as appropriate, so as to fall within the above range.

The amount of the crystalline polyester resin is preferably from 5 parts by mass to 30 parts by mass, more preferably from 8 parts by mass to 30 parts by mass, even more preferably from 10 parts by mass to 25 parts by mass, and further preferably from 10 parts by mass to 20 parts by mass with respect to 100 parts by mass of the binder resin.

The crystalline polyester resin can be manufactured by the usual polyester synthesis method. For example, the crystalline polyester resin can be obtained by subjecting an acid component and an alcohol component to an esterification reaction or a transesterification reaction, and then performing a polycondensation reaction under a reduced pressure or by introducing a nitrogen gas according to a conventional method.

At the time of the esterification or transesterification reaction, a normal esterification catalyst or transesterification catalyst such as sulfuric acid, tertiary butyl titanium butoxide, dibutyltin oxide, manganese acetate, magnesium acetate, or the like can be used if necessary. Regarding polymerization, it is possible to use a usual polymerization catalyst such as tert-butyl titanium butoxide, dibutyltin oxide, tin acetate, zinc acetate, tin disulfide, antimony trioxide, germanium dioxide, and the like. The polymerization temperature and the amount of catalyst are not particularly limited and may be arbitrarily selected as needed.

It is desirable that a titanium catalyst be used as the catalyst, and a chelate-type titanium catalyst is more desirable. This is because the reactivity of the titanium catalyst is appropriate and a polyester having a molecular weight distribution desired in the present invention can be obtained.

Colorant

A colorant may be used in the toner. Examples of the colorant include the following organic pigments, organic dyes, and inorganic pigments.

Examples of cyan colorants include copper phthalocyanine compounds and derivatives thereof, anthraquinone compounds, and basic dye lake compounds.

Examples of magenta colorants are presented hereinbelow. Condensed azo compounds, diketopyrrolopyrrole compounds, anthraquinone compounds, quinacridone compounds, basic dye lake compounds, naphthol compounds, benzimidazolone compounds, thioindigo compounds, and perylene compounds.

Examples of yellow colorants include condensed azo compounds, isoindolinone compounds, anthraquinone compounds, azo metal complexes, methine compounds, and allylamide compounds.

Examples of black colorants include carbon black, and those toned in black using the abovementioned yellow-based colorant, magenta-based colorant, cyan-based colorant, and magnetic powder.

These colorants can be used alone or in a mixture, and can also be used in a solid solution state. The colorant used in the present invention is selected from the viewpoints of hue angle, saturation, brightness, light resistance, OHP transparency, and dispersibility in a toner particle.

The amount of the colorant is preferably from 1 part by mass to 10 parts by mass with respect to 100 parts by mass of the binder resin.

Magnetic Particles

Magnetic particles may be used as the black colorant.

When using magnetic particles, it is preferable to have a core particle including a magnetic iron oxide particle and a coating layer provided on the surface of the core particle.

The core particle including the magnetic iron oxide particles can be exemplified by magnetic iron oxides such as magnetite, maghemite, and ferrite and magnetic iron oxides that contain other metal oxides, and by metals such as Fe, Co, and Ni and alloys of these metals with metals such as Al, Co, Cu, Pb, Mg, Ni, Sn, Zn, Sb, Be, Bi, Cd, Ca, Mn, Ti, W, and V, and their mixtures.

The coating layer may cover the entire surface of the core particle uniformly, or may cover the surface of the core particle in a partially exposed state. In either of the coating modes, the coating layer is preferably the outermost layer, and the surface of the core particles is preferably thinly coated. It is preferable that Si and Al be contained as elements forming the coating layer.

A method for forming the coating layer is not particularly limited, and a known method may be used. For example, after producing core particles including magnetite, a silicon source or an aluminum source such as sodium silicate or aluminum sulfate is added to a ferrous sulfate aqueous solution. Then, a coating layer including a specific oxide on the surface of the core particle may be formed by blowing air while adjusting the pH and temperature of the mixed solution.

Further, the thickness of the coating layer can be controlled by adjusting the addition amount of ferrous sulfate aqueous solution, sodium silicate, aluminum sulfate, and the like.

Further, from the viewpoint of facilitating the formation of the above-described coating layer and improving magnetic properties and tinting strength, the magnetic particles preferably have an octahedral shape.

As a method for controlling the shape of magnetic particles, a conventionally known method can be adopted. For example, magnetic particles can be formed into an octahedral shape by adjusting the pH during a wet oxidation reaction to 9 or more in the production of core particles.

From the viewpoint of low-temperature fixability, the amount of the magnetic particles is preferably from 25 parts by mass to 100 parts by mass, and more preferably from 30 parts by mass to 90 parts by mass with respect to 100 parts by mass of the binder resin.

Other Constituent Materials of Toner

It is preferable that the toner particle include a release agent (wax) in order to give the toner releasability.

The following are specific examples of wax.

oxides of aliphatic hydrocarbon waxes, such as oxidized polyethylene wax, and their block copolymers; waxes in which the major component is fatty acid ester, such as carnauba wax, sasol wax, and montanic acid ester waxes; and waxes provided by the partial or complete deacidification of fatty acid esters, such as deacidified carnauba wax; saturated straight-chain fatty acids such as palmitic acid, stearic acid, and montanic acid; unsaturated fatty acids such as brassidic acid, eleostearic acid, and parinaric acid; saturated alcohols such as stearyl alcohol, aralkyl alcohols, behenyl alcohol, carnaubyl alcohol, ceryl alcohol, and melissyl alcohol; long-chain alkyl alcohols; polyhydric alcohols such as sorbitol; fatty acid amides such as linoleamide, oleamide, and lauramide; saturated fatty acid bisamides such as methylenebisstearamide, ethylenebiscapramide, ethylenebislauramide, and hexamethylenebisstearamide; unsaturated fatty acid amides such as ethylenebisoleamide, hexamethylenebisoleamide, N,N□-dioleyladipamide, and N,N-dioleylsebacamide; aromatic bisamides such as m-xylenebisstearamide and N,N-distearylisophthalamide; fatty acid metal salts (generally known as metal soaps) such as calcium stearate, calcium laurate, zinc stearate, and magnesium stearate; waxes provided by grafting an aliphatic hydrocarbon wax using a vinylic monomer such as styrene or acrylic acid; partial esters between a polyhydric alcohol and a fatty acid, such as behenic monoglyceride; and hydroxyl group-containing methyl ester compounds obtained by the hydrogenation of plant oils.

The following are specific examples: VISKOL (registered trademark) 330-P, 550-P, 660-P, and TS-200 (Sanyo Chemical Industries, Ltd.); Hi-WAX 400P, 200P, 100P, 410P, 420P, 320P, 220P, 210P, and 110P (Mitsui Chemicals, Inc.); Sasol H1, H2, C80, C105, and C77 (Sasol Wax GmbH); HNP-1, HNP-3, HNP-9, HNP-10, HNP-11, and HNP-12 (Nippon Seiro Co., Ltd.); UNILIN (registered trademark) 350, 425, 550, and 700 and UNICID (registered trademark) 350, 425, 550, and 700 (Toyo Petrolite Co., Ltd.); and Japan Wax, Beeswax, Rice Wax, Candelilla Wax, and Carnauba Wax (Cerarica NODA Co., Ltd.).

From the viewpoint of low-temperature fixability, it is preferable that the wax have a melting point of from 65.0° C. to 120.0° C. Further, the difference between the melting point of the wax and the melting point of the crystalline polyester resin is preferably from 0° C. to 25° C., and more preferably from 0° C. to 35° C.

Wax is more likely to crystallize in a toner particle at room temperature than a crystalline polyester resin. By reducing the difference between the melting points, the crystallization of the crystalline polyester resin is promoted along with the crystallization of the wax, so that the following Tg1 can be easily controlled within a specific range.

The toner may contain a charge control agent in order to stabilize its triboelectric charging behavior.

The content of the charge control agent, while also varying as a function of its type and the properties of the other constituent materials of the toner, is generally, per 100 mass parts of the binder resin, preferably from 0.1 mass parts to 10 mass parts and more preferably from 0.1 mass parts to 5 mass parts.

Charge control agents that control the toner to a negative charging performance and charge control agents that control the toner to a positive charging performance are known for charge control agents, and a single one of the various charge control agents or two or more can be used depending on the toner type and application.

The following are examples of charge control agents for controlling the toner to a negative charging performance:

organometal complexes (monoazo metal complexes, acetylacetone metal complexes); the metal complexes and metal salts of aromatic hydroxycarboxylic acids and aromatic dicarboxylic acids; aromatic mono- and polycarboxylic acids and their metal salts and anhydrides; and phenol derivatives such as esters and bisphenols.

The following are examples of charge control agents for controlling the toner to a positive charging performance:

nigrosine and its modifications by fatty acid metal salts; quaternary ammonium salts such as tributylbenzylammonium 1-hydroxy-4-naphthosulfonate and tetrabutylammonium tetrafluoroborate, and their analogues; onium salts such as phosphonium salts, and their lake pigments; triphenylmethane dyes and their lake pigments (the laking agent can be exemplified by phosphotungstic acid, phosphomolybdic acid, phosphotungstomolybdic acid, tannic acid, lauric acid, gallic acid, ferricyanic acid, and ferrocyanic compounds); and metal salts of higher fatty acids.

Nigrosine compounds and quaternary ammonium salts, for example, are preferred among the preceding.

A charge control resin may also be used, and it may also be used in combination with the charge control agents cited above. Specific examples of the charge control agents are as follows:

Spilon Black TRH, T-77, T-95, and TN-105 (Hodogaya Chemical Co., Ltd.); BONTRON (registered trademark)S-34, S-44, E-84, and E-88 (Orient Chemical Industries Co., Ltd.); TP-302 and TP-415 (Hodogaya Chemical Co., Ltd.); BONTRON (registered trademark)N-01, N-04, N-07, and P-51 (Orient Chemical Industries Co., Ltd.); and Copy Blue PR (Clariant International Ltd,).

The toner may have silica fine particles or the like as an external additive in order to improve charging stability, durable developing property, flowability and durability.

This silica fine particles have a specific surface area by the nitrogen adsorption-based BET method preferably of at least 30 m²/g and more preferably from 50 m²/g to 400 m²/g. The amount of the silica fine particles expressed per 100 mass parts of the toner particle is preferably at from 0.01 mass parts to 8.00 mass parts and more preferably at from 0.10 mass parts to 5.00 mass parts.

The BET specific surface area of the silica fine particles can be determined using a multipoint BET method by the adsorption of nitrogen gas to the surface of the silica fine particles using, for example, an Autosorb 1 specific surface area analyzer (Yuasa Ionics Co., Ltd.), a GEMINI 2360/2375 (Micromeritics Instrument Corporation), or a TriStar-3000 (Micromeritics Instrument Corporation).

For the purpose of controlling the triboelectric charging characteristics, the silica fine particles are optionally preferably also treated with a treatment agent, e.g., an unmodified silicone varnish, various modified silicone varnishes, an unmodified silicone oil, various modified silicone oils, a silane coupling agent, a functional group-bearing silane compound, or other organosilicon compounds, or with a combination of different treatment agents.

Other external additives may also be added to the toner on an optional basis. These external additives can be exemplified by resin fine particles and inorganic fine particles that function as an auxiliary charging agents, agents that impart electroconductivity, flowability-imparting agents, anti-caking agents, release agents for hot roll fixing, lubricants, abrasive, and so on.

The lubricant can be exemplified by polyethylene fluoride powders, zinc stearate powders, and polyvinylidene fluoride powders. The abrasive can be exemplified by cerium oxide powders, silicon carbide powders, and strontium titanate powders. Strontium titanate powders are preferred among the preceding.

The toner may be used as a two-component developer by mixing with a carrier. An ordinary carrier, e.g., ferrite, magnetite, and so forth, or a resin-coated carrier may be used as the carrier. A binder-type carrier, in which a magnetic body is dispersed in a resin, may also be used.

Resin-coated carriers comprise a carrier core particle and a coating material, i.e., a resin, coated on the surface of the carrier core particle. The resins used for the coating material can be exemplified by styrene-acrylic resins such as styrene-acrylate ester copolymers and styrene-methacrylate ester copolymers; acrylic resins such as acrylate ester copolymers and methacrylate ester copolymers; fluororesins such as polytetrafluoroethylene, monochlorotrifluoroethylene polymers, and polyvinylidene fluoride; silicone resins; polyester resins; polyamide resins; polyvinyl butyral; and aminoacrylate resins.

Other examples include ionomer resins and polyphenylene sulfide resins. These resins can be used alone or in combination of two or more.

In differential scanning calorimeter (DSC) measurement of the toner, where

(i) the number of cold crystallization peaks in a range of from 40° C. to 120° C. at the time of lowering temperature is X, and
(ii) the number of endothermic peaks in a range of from 40° C. to 120° C. at the time of a second temperature rise is Y,

X and Y satisfy following formulas (7) and (8). More preferably following formulas (7′) and (8′) are satisfied, and even more preferably X=1 and Y=2.

X≥1 (7)

Y≥X+1 (8)

2≥X≥1 (7′)

Y=X+1. (8′)

With the above features, the crystallization speed of the crystalline polyester resin is increased and the heat-resistant storage stability is improved. The reason for this is considered hereinbelow.

As mentioned above, a crystalline polyester resins takes a long time to crystallize. In general, a crystalline polyester resin that has not been completely crystallized causes a decrease in the glass transition temperature (Tg) of the toner, and thus tends to deteriorate the heat-resistant storage stability.

It is preferable that the toner particle include a crystalline polyester resin and a wax that is easily oriented. It is considered that such wax can accelerate the crystallization rate of the crystalline polyester resin. It is also considered that when X and Y satisfy the above relational expression, the crystalline polyester resin and the wax are oriented.

The toner particle preferably includes a crystalline polyester resin.

Further, in differential scanning calorimetry of the toner,

a temperature is raised from 25° C. to 120° C. at a rate of 1000° C./sec (first temperature rise process),

the temperature is held (high-temperature holding process) at 120° C. for 100 msec (0.100 second) and then cooling is performed to 25° C. at a rate of 1000° C./sec (cooling process), and then

the temperature is raised to 120° C. at a rate of 1000° C./sec (second temperature rise process), and

when a glass transition temperature at the first temperature rise is Tg1 (° C.), and a glass transition temperature at the second temperature rise is Tg2 (° C.), following formulas (9) and (10) are preferably satisfied.

65° C.≤Tg1≤85° C. (9)

7° C.≤Tg1-Tg2≤30° C. (10)

Such DSC measurement conditions correspond to the heat that the toner receives from the fixing device. Specifically, the temperature and time of the high-temperature holding process were adjusted so that heat could be received at 120° C. for 100 msec. The glass transition temperature Tg2 obtained by the measurement in the second temperature rising process shows the degree of plasticity of the crystalline polyester resin to the toner at the time the heat is received.

That is, the increase in Tg1-Tg2 indicates that the crystalline polyester resin can sufficiently plasticize the toner even if the heating is performed for a very short time.

Here, in order to reduce heat other than that of the high-temperature holding process, the temperature rise rate was set to a very high value of 1000° C./sec, so that the toner does not receive too much heat outside the high-temperature holding process. Further, in order to make the plasticity of the crystalline polyester resin to the toner close to that when passing through the fixing device, the cooling rate was set to a very high value of 1000° C./sec.

This is because the crystalline polyester plasticizes the toner when kept at 120° C. for 100 msec, but where the cooling rate is low, the crystalline polyester crystallizes during the cooling process. Therefore, Tg2 obtained in the second temperature rise process is affected by two factors, namely, plasticization in the high-temperature holding process and crystallization in the cooling process, and it is highly probable that the desired state will not be measured.

Shown hereinbelow are the measurement conditions that are often used for conventional measurements in comparison with such DSC measurement conditions:

the temperature is raised from 25° C. to 120° C. at a rate of 10° C./min (first temperature increase process);

the temperature is held at 120° C. for 5 minutes (high-temperature holding process);

cooling is performed to 25° C. at a rate of 10° C./min (cooling process), and then

the temperature is raised to 120° C. at a rate of 10° C./min (second temperature rise process).

In this measurement, since the high-temperature holding process is longer than in the conditions of the present invention, it is highly probable that the crystalline polyester resin will sufficiently plasticize the toner even if the toner is so configured that the plasticization speed to the toner is not sufficient.

Meanwhile, in the present invention, it is shown that the crystalline polyester can plasticize the toner even in a very short high-temperature holding process.

Formula (9) indicates that the glass transition temperature Tg1 (° C.) of the toner in the first temperature rise process is from 65° C. to 85° C. Tg1 is higher than the result obtained with Tg measured at a temperature rise rate of 10° C./min which is a conventional measurement condition.

Where Tg1 is 65° C. or higher, a toner having satisfactory storability can be obtained. Further, where Tg1 is 85° C. or less, a toner having satisfactory low-temperature fixability can be obtained. Tg1 is preferably from 70° C. to 80° C.

The formula (10) indicates that the difference between the glass transition temperature Tg2 of the toner in the second temperature rise process and the glass transition temperature Tg1 of the toner in the first temperature rise process is from 7° C. to 30° C. When the formula (10) is satisfied, it means that the crystalline polyester resin can plasticize the toner even with a very short high-temperature holding time.

As a result, the toner can be sufficiently plasticized within a very short time when the medium passes through the fixing device. For this reason, it is possible to obtain a toner for which both satisfactory low-temperature fixability and suppression of solid image density unevenness can be achieved. Tg1-Tg2 is preferably from 10° C. to 30° C. Tg1-Tg2 can be controlled by, for example, changing the composition of the resin components in the toner or the composition of a fixing aid.

Tg2 is preferably from 40° C. to 75° C., and more preferably from 45° C. to 70° C.

The preferred composition of the toner is described below.

In order to satisfy the formulas (9) and (10), it is preferable that the crystalline polyester resin plasticize the toner even at a very short high temperature holding time. This can be achieved by a method of making the crystalline polyester resin easily compatible with the binder resin of the toner when receiving heat.

Examples of specific means include selecting a compound that constitutes the crystalline polyester resin, selecting a compound that constitutes the binder resin, and bringing the solubility parameter SP values of the crystalline polyester resin and the binder resin close to each other; improving the dispersibility of the crystalline polyester resin in the toner particle; and improving the crystallinity of the crystalline polyester. By combining these, formulas (9) and (10) can be satisfied.

In the temperature T (° C.)-storage elastic modulus G′ (Pa) curve obtained at a temperature rise rate of 2.0° C./min by measuring the toner with a rotating plate rheometer, a temperature at which the storage elastic modulus is 1.0×10³ Pa is T1 (° C.),

on a DSC curve obtained by differential scanning calorimetry of the toner, there is an endothermic peak in a range of from 30° C. to 120° C., and where a peak temperature of a peak present on a lowest temperature side of the endothermic peak is T2 (° C.), a following formula (11) is satisfied.

T1-T2≥40. (11)

Generally, a binder resin (for example, an amorphous resin) has a glass transition point (Tg). The viscosity of the binder resin exceeding Tg gradually decreases, but the rate of decrease in viscosity is slow. Meanwhile, a crystalline material (crystalline polyester resin, wax, and the like) has a melting point inherent to the material, and when the crystalline material reaches the melting point or a higher temperature, the viscosity sharply decreases.

This behavior is the same when the toner includes a crystalline material, and if the difference in viscosity between the crystalline material and the binder resin is too large, the crystalline material separates from the binder resin, which can result in solid image density unevenness. That is, it is preferable that the difference between the melting point of the crystalline material and the temperature at which the toner reaches a specific viscosity be small. When T1-T2 satisfies the relationship of formula (11), it is possible to suppress solid image density unevenness.

More preferably, Ti-T2 is from 0 to 35.

Method for Producing Toner

A method for producing the toner is not particularly limited, and a known production method can be adopted. Hereinafter, a method for producing the toner through a melt-kneading step and a pulverization step will be specifically illustrated, but this method is not limiting.

For example, the binder resin, and optionally the crystalline polyester resin, colorant, a release agent, charge control agent, and other additives may be thoroughly mixed using a mixer such as a Henschel mixer or a ball mill (mixing step). The resulting mixture may be melt-kneaded using a heated kneader such as a twin-screw kneader-extruder, hot roll, kneader, or extruder (melt-kneading step).

The resulting melt-kneaded material may be cooled and solidified and then pulverized using a pulverizer (pulverization step), followed by classification using a classifier (classification step) to obtain toner particles. The toner particles may optionally also be mixed with an external additive using a mixer such as a Henschel mixer to obtain a toner.

The mixer can be exemplified by the following: the FM mixer (Nippon Coke & Engineering Co., Ltd.); Supermixer (Kawata Mfg. Co., Ltd.); Ribocone (Okawara Corporation); Nauta mixer, Turbulizer, and Cyclomix (Hosokawa Micron Corporation); Spiral Pin Mixer (Pacific Machinery & Engineering Co., Ltd.); and Loedige Mixer (Matsubo Corporation).

The kneading apparatus can be exemplified by the following: the KRC Kneader (Kurimoto, Ltd.); Buss Ko-Kneader (Buss Corp.); TEM extruder (Toshiba Machine Co., Ltd.); TEX twin-screw kneader (The Japan Steel Works, Ltd.); PCM Kneader (Ikegai Ironworks Corporation); three-roll mills, mixing roll mills, and kneaders (Inoue Manufacturing Co., Ltd.); Kneadex (Mitsui Mining Co., Ltd.); model MS pressure kneader and Kneader-Ruder (Moriyama Mfg. Co., Ltd.); and Banbury mixer (Kobe Steel, Ltd.).

The pulverizer can be exemplified by the following: Counter Jet Mill, Micron Jet, and Inomizer (Hosokawa Micron Corporation); IDS mill and PJM Jet Mill (Nippon Pneumatic Mfg. Co., Ltd.); Cross Jet Mill (Kurimoto, Ltd.); Ulmax (Nisso Engineering Co., Ltd.); SK Jet-O-Mill (Seishin Enterprise Co., Ltd.); Kryptron (Kawasaki Heavy Industries, Ltd.); Turbo Mill (Turbo Kogyo Co., Ltd.); and Super Rotor (Nisshin Engineering Inc.).

The classifier can be exemplified by the following: Classiel, Micron Classifier, and Spedic Classifier (Seishin Enterprise Co., Ltd.); Turbo Classifier (Nisshin Engineering Inc.); Micron Separator, Turboplex (ATP), and TSP Separator (Hosokawa Micron Corporation); Elbow Jet (Nittetsu Mining Co., Ltd.); Dispersion Separator (Nippon Pneumatic Mfg. Co., Ltd.); and YM Microcut (Yasukawa Shoji Co., Ltd.).

The following screening devices may be used to screen out the coarse particles: Ultrasonic (Koei Sangyo Co., Ltd.), Rezona Sieve and Gyro-Sifter (Tokuju Corporation), Vibrasonic System (Dalton Co., Ltd.), Soniclean (Sintokogio, Ltd.), Turbo Screener (Turbo Kogyo Co., Ltd.), Microsifter (Makino Mfg. Co., Ltd.), and circular vibrating sieves.

An annealing step may be performed in order to facilitate the control of the minimum value of the change amount (dG′/dT) in the storage elastic modulus G′ with respect to the temperature T. The annealing step is a step of crystallizing a crystalline material such as a crystalline polyester resin in the toner particle.

In particular, when a crystalline polyester resin that easily plasticizes the binder resin is used, it is preferable to crystallize the crystalline polyester resin by an annealing step in order to sufficiently promote the crystallization of the crystalline polyester resin at a normal temperature.

Methods for measuring the physical properties are described hereinbelow. Method for Measuring Storage Elastic Modulus G′ (80° C.) and Storage Elastic Modulus G′ (120° C.)

### (1) Preparation of Measurement Sample

A cylindrical sample having a diameter of 8 mm and a height of 2.0±0.3 mm is prepared as a measurement sample by compression-molding about 0.15 g (variable depending on the specific gravity of the sample) of a toner or a THF-insoluble matter of the toner for 60 sec under 20 MPa by using a tablet molding compressor in an environment of 25° C.

### (2) Mounting the Sample

A rotating plate rheometer “ARES” (manufactured by TA INSTRUMENTS) is used as the measuring device. The sample is mounted on a parallel plate, an Axial Force is adjusted to 250-300 and Hold is performed. Next, the temperature is raised from room temperature (25° C.) to 65° C. (adjusted, as appropriate, within the range of toner Tg+5° C. to Tg+10° C.) and maintained at this temperature for 10 minutes. The sample shape is thereafter adjusted and the sample is cooled to 30° C.

### (3) Measurement

The measurement is performed under the following conditions.

A parallel plate with a diameter of 8 mm is used.

The frequency (Frequency) is set to 6.28 rad/sec (1.0 Hz).

The initial value of applied strain (Strain) is set to 0.1%.

The measurement is performed at a temperature rise rate (Ramp Rate) of 2.0° C./min between 50° C. and 120° C. and at a temperature lowering rate (Ramp Rate) of 2.0° C./min between 120° C. and 50° C. In addition, the measurement is performed under the setting conditions of the following automatic adjustment mode. The measurement is performed in an automatic distortion adjustment mode (Auto Strain).

The maximum strain (Max Applied Strain) is set to 20.0%.

The maximum torque (Max Allowed Torque) is set to 200.0 g·cm, and the minimum torque (Min Allowed Torque) is set to 0.2 g·cm.

The distortion adjustment (Strain Adjustment) is set to 20.0% of Current Strain. In the measurement, the automatic tension adjustment mode (Auto Tension) is adopted.

The automatic tension direction (Auto Tension Direction) is set to compression (Compression).

The initial static force (Initial Static Force) is set to 10.0 g, and the automatic tension sensitivity (Auto Tension Sensitivity) is set to 40.0 g.

The operating condition of the automatic tension (Auto Tension) is set to 1.0×10² (Pa) or more for the sample modulus.

The storage elastic modulus G′ (80° C.) and the storage elastic modulus G′ (120° C.) are determined from the temperature T (° C.)-storage elastic modulus G′ (Pa) curve obtained by the above method.

Further, dG′/dT is calculated for every two consecutive plots, and the local minimum value of the change amount (dG′/dT) of the storage elastic modulus G′ with respect to the temperature T in the range of from 60° C. to 80° C. is obtained.

Also, the temperature T1 (° C.) at which the storage elastic modulus becomes 1.0×10³ Pa is read from the obtained temperature T (° C.)-storage elastic modulus G′ (Pa) curve.

Method for Measuring S₂/S₁×1/R₁

The projected area S₁ of the toner at 80° C., the radius R₁ of the projected area of the toner at 80° C., and the projected area S₂ of the toner at 120° C. were measured in the following manner.

### (1) Preparation of Measurement Sample

Premium Presentation 120 g Laser Paper (HP) is cut into a 10 mm square, and the toner is attached onto the Premium Presentation 120 g Laser Paper (HP). A cotton swab is used to attach the toner, and the toner is attached so that each particle is scattered on the Premium Presentation 120 g Laser Paper (HP).

### (2) Measurement

The Premium Presentation 120 g Laser Paper (HP) with the toner attached thereto is set on a heating plate (a cooling and heating stage TH-600PM for a Linkam microscope). The temperature of the heating plate is then raised at 10° C./min, and still images at 80° C. and 120° C. are captured while observing with an optical microscope. Next, image analysis software (Image J) is used to calculate the projected area S₁ of the toner at 80° C., the radius R₁ of the projected area of the toner at 80° C., and the projected area S₂ of the toner at 120° C. from the captured still image.

S₁, R₁, and S₂ are calculated as arithmetic mean values of 100 particles. When the toner has a non-spherical shape, the toner radius is calculated using the average value of the major axis and the minor axis of the toner particle as the toner diameter.

Measurement of Glass Transition Temperatures Tg1 and Tg2

The glass transition temperature Tg1 (° C.) and the glass transition temperature Tg2 (° C.) are measured using a differential scanning calorimeter “Flash DSC1 STARe System” (manufactured by METTLER TOLEDO).
Measurement Procedure

The toner is placed on a dedicated chip sensor that has been temperature-corrected in advance. The temperature control of the chip sensor is performed in the following manner.

The temperature is maintained at 25° C. for 10 sec and then raised to 120° C. at a temperature rise rate of 1000° C./sec (first temperature rise process). After maintaining the temperature at 120° C. for 100 msec (high temperature holding process), cooling is performed to 25° C. at a cooling rate of 1000° C./sec (cooling process). After maintaining the temperature at 25° C. for 100 msec, the temperature is raised to 120° C. at a temperature rise rate of 1000° C./sec (second temperature rise process).

In the above temperature control, the glass transition temperature Tg1 (° C.) is calculated from the temperature rise curve showing the endothermic quantity obtained in the first temperature rise process.

Also, the glass transition temperature Tg2 (° C.) is calculated from the temperature rise curve showing the endothermic quantity obtained in the second temperature rise process.

Method for Measuring the Content of Ethyl Acetate-Insoluble Matter

Approximately 1.5 g of the toner is exactly weighed out (W1 [g]) and is introduced into a pre-weighed extraction thimble (product name: No. 86R, size 28×100 mm, Toyo Roshi Kaisha, Ltd.), and this is set into a Soxhlet extractor.

Extraction is carried out for 18 hours using 200 mL of ethyl acetate as the solvent. Extraction is run here at a reflux rate that provides an extraction cycle for the solvent of once in approximately 5 minutes.

After extraction is finished, the extraction thimble is removed and air dried followed by vacuum drying for 24 hours at 50° C. The mass of the extraction thimble containing the extraction residue is measured, and the mass (W2 [g]) of the extraction residue is calculated by subtracting the mass of the extraction thimble.

The content (W3, [g]) of components other than the binder resin is then determined using the following procedure.

Approximately 2 g of toner is exactly weighed (Wa [g]) into a pre-weighed 30-mL magnetic crucible.

The magnetic crucible is placed into an electric oven and heating is performed for about 3 hours at approximately 900° C.; cooling is carried out in the electric oven; cooling is carried out for at least 1 hour in a desiccator at normal temperature; the mass of the crucible containing the pyrolysis residue is measured; and the pyrolysis residue (Wb [g]) is determined by subtracting the mass of the crucible.

The mass (W3 [g]) of the pyrolysis residue in the sample W1 [g] is calculated using the following formula (A).

W3=W1×(Wb/Wa) (A)

In this case, the content of the ethyl acetate-insoluble matter in the binder resin is calculated using the following formula (B).

Ethyl acetate−insoluble matter in binder resin={(W2−W3)/(W1-W3)}×100 (B)

Method for Measuring Amount of Tetrahydrofuran (THF)-Insoluble Matter

The amount of resin-derived THF-insoluble matter is determined by the same method as in the <Method for Measuring Ethyl Acetate-Insoluble Matter> except that the solvent was changed to THF.

In the process of obtaining the THF-insoluble matter, the storage elastic modulus G′ (120° C.) can be measured by a method using the above-described rotating plate rheometer by using a sample that has been vacuum dried for 24 hours at 50° C. after Soxhlet extraction.

Measurement of Peak Temperature T2

In the DSC curve obtained by differential scanning calorimetry of the toner, the peak temperature T2 (° C.) of the peak present on the lowest temperature side among the endothermic peaks in the range of from 30° C. to 120° C. is measured in the following manner.

The measurement is performed using a differential scanning calorimeter “Q1000” (manufactured by TA Instruments) according to ASTM D3418-82. The melting points of indium and zinc are used for temperature correction of the device detection unit, and the heat of fusion of indium is used to correct the quantity of heat.

Specifically, about 5 mg of a measurement sample is precisely weighed and put into an aluminum pan, an empty aluminum pan is used as a reference, and the measurement is performed at normal temperature and normal humidity at a temperature rise rate of 10° C./min in the measurement temperature range of from 30° C. to 120° C. The temperature of the peak top present on the lowest temperature side among the endothermic peaks in the temperature range of from 30° C. to 120° C. in the DSC curve obtained in this temperature rise process is taken as T2 (° C.).

Measurement of Number X of Cold Crystallization Peaks and Number Y of Endothermic Peaks During Second Temperature Rise in DSC Measurement

The number X of cold crystallization peaks and the number Y of endothermic peaks during the second temperature rise are measured in the following manner.

The measurement is performed using a differential scanning calorimeter “Q1000” (manufactured by TA Instruments) according to ASTM D3418-82. The melting points of indium and zinc are used for temperature correction of the device detection unit, and the heat of fusion of indium is used to correct the quantity of heat.

Specifically, about 5 mg of a measurement sample is precisely weighed and put into an aluminum pan, an empty aluminum pan is used as a reference, and the measurement is performed at normal temperature and normal humidity at a temperature rise rate of 10° C./min in the measurement temperature range of from 30° C. to 180° C. In the measurement, the temperature is once raised to 180° C., then lowered to 30° C. at a rate of 10° C./min, and then raised again.

In the DSC curve obtained in this cooling process, the number of exothermic peaks in the temperature range of from 40° C. to 120° C. is taken as the number X of cold crystallization peaks. Further, in the DSC curve obtained in the second temperature rise process, the number of endothermic peaks in the temperature range of from 40° C. to 120° C. is taken as the number of endothermic peaks Y during the second temperature rise.

Measurement of C1 and C2 from Toner

The molecular structure of the crystalline polyester resin can be confirmed by NMR measurement with a solution or a solid sample and also by a known analysis method such as X-ray diffraction, GC/MS, LC/MS, IR measurement, and the like. Also, a known method can be used for isolating the crystalline polyester resin from the toner.

Specifically, the isolation operation is performed in the following manner. First, the toner is dispersed in ethanol, which is a poor solvent for the toner, and the temperature is raised to a temperature exceeding the melting point of the crystalline polyester resin. At this time, pressure may be applied if necessary. At this point in time, the crystalline polyester resin having a temperature above the melting point is melted. After that, the crystalline polyester resin can be collected from the toner by solid-liquid separation.

Measurement of Amount of Structure in Which at Least One Selected from Group Consisting of Acrylic Acid Ester and Methacrylic Acid Ester in Vinyl Polymer Segment of Hybrid Resin Contained in Toner is Polymerized

Confirmation can be made by NMR measurement with a solid sample and also by a known analysis method such as X-ray diffraction, GC/MS, LC/MS, IR measurement, and the like.

Measurement of Amount of Amorphous Polyester Segment in Hybrid Resin Contained in Toner

Confirmation can be made by NMR measurement with a solid sample and also by a known analysis method such as X-ray diffraction, GC/MS, LC/MS, IR measurement, and the like.

### EXAMPLES

The present invention will be specifically described hereinbelow based on the following examples. However, the present invention is not limited thereto. In the following formulations, parts and % are based on mass unless otherwise specified.

Production Example of Long-Chain Alkyl Monomer (W-1)

A total of 1200 parts of a chain saturated hydrocarbon having an average value of a carbon number of 35 was placed in a glass cylindrical reaction vessel, and 38.5 parts of boric acid was added at a temperature of 140° C. Immediately thereafter, a mixed gas of 50% by volume of air and 50% by volume of nitrogen with an oxygen concentration of about 10% by volume was blown at a rate of 20 L/min, and the reaction was carried out at 200° C. for 3.0 hours. After the reaction, warm water was added to the reaction solution, hydrolysis was carried out at 95° C. for 2 hours, the product was allowed to stand, and then a reaction product (modified product) in the upper layer was obtained.

A total of 20 parts of the obtained modified product was added to 100 parts of n-hexane and purified to dissolve and remove a part of the unmodified component to obtain a long-chain alkyl monomer (W-1). The long-chain alkyl monomer (W-1) had a modification ratio of 93.6% by mass, that is, contained 6.4% by mass of aliphatic hydrocarbon. Table 1 shows the physical properties.

TABLE 1

| Long-chain | | Average | |
|---|---|---|---|
| alkyl | | value of | Modification |
| monomer | Long-chain | carbon | ratio |
| No. | alkyl type | number | (% by mass) |
| W-1 | Saturated monoalcohol | 35 | 93.6 |
| | modification product | | |
| | (secondary) | | |
| W-2 | Saturated monoalcohol | 48 | 80.3 |
| (※) | modification product | | |
| | (primary) | | |

In Table 1, W-2 (*) is UNILIN 700 (manufactured by Toyo Petrolite Co., Ltd.).

Production Example of Resin Composition (A-1)

Ethylene oxide adduct (2.0 mole addition) of bisphenol A 20.0 mol parts

Propylene oxide adduct (2.3 mole addition) of bisphenol A 80.0 mol parts

Terephthalic acid 67.0 mol parts

Dodecanedioic acid 7.0 mol parts

In addition to 96 parts of the above polyester monomer, the long-chain alkyl monomer (W-1) was added to obtain 5.0% by mass with respect to the entire polyester resin composition. The obtained mixture was charged into a four-necked flask, a depressurizing device, a water separator, a nitrogen gas introducing device, a temperature measuring device and a stirrer were mounted, and stirring was performed at 160° C. under a nitrogen atmosphere.

Then, a mixture of 4 parts of a vinyl-based polymerization monomer (styrene: 10.0 mol parts, butyl acrylate: 90.0 mol parts) constituting the vinyl polymer segment and 0.7 parts of benzoyl peroxide as a polymerization initiator was added dropwise from a funnel over 4 hours.

Then, after performing the reaction at 160° C. for 5 hours, the temperature was raised to 200° C., 0.15 parts of titanium diisopropylate bistriethanolaminate and 0.01 parts of gallic acid were added, and a polycondensation reaction was thereafter performed at 230° C. for 6 hours, and the reaction was further performed at 230° C. and 8.0 kPa for 1 hour. After cooling to 180° C., 0.01 parts of tert-butylcatechol and 15.0 mol parts of trimellitic anhydride with respect to the polyester monomer were charged, and the reaction time was adjusted so as to obtain a desired viscosity. After completion of the reaction, the resin composition (A-1) was taken out from the vessel, cooled and pulverized to obtain a resin composition (A-1). Table 2 shows the physical properties.

Production Example of Resin Compositions (A-2) to (A-12)

Resin compositions (A-2) to (A-12) were obtained in the same manner as in the Production Example of Resin Composition (A-1) except that the monomer formulation shown in Table 3 was changed. Table 2 shows the physical properties.

Production Example of Resin Composition (A-13)

A total 6550 g of the alcohol components and carboxylic acid components, other than trimellitic anhydride, that are shown in Table 3, 45 g of tin (II) 2-ethylhexanoate and 5 g of gallic acid were placed into a 10-liter four-necked flask equipped with a nitrogen introducing tube, a dehydration tube equipped with a fractionation tube through which hot water at 100° C. was flowing, a stirrer and a thermocouple, the flask was held at 180° C. for 1 hour in a nitrogen atmosphere, the temperature was thereafter raised from 180° C. to 230° C. at 10° C./h, and then a polycondensation reaction was performed at 230° C. for 6 hours.

After conducting the reaction at 230° C. and 8.0 kPa for 1 hour, trimellitic anhydride was further reacted at 210° C., and the reaction time was adjusted to obtain a desired viscosity. After the reaction was completed, the resin composition was taken out from the vessel, cooled and pulverized to obtain a resin composition (A-13). Table 2 shows the physical properties.

Production Example of Resin Composition (A-14)

Of the monomers listed in Table 3, the raw material monomers of the polyester resin other than fumaric acid and trimellitic anhydride were placed in a 10-liter four-necked flask equipped with a dehydration tube equipped with a nitrogen inlet tube, a stirrer and a thermocouple, and the temperature was raised to 160° C. in a mantle heater under a nitrogen atmosphere.

After that, the mixture of the raw material monomers of vinyl resin and the polymerization initiator was added dropwise by the dropping funnel over 1 hour. After the dropping, the addition polymerization reaction was matured for 1 hour while maintaining the temperature at 160° C., then the temperature was raised to 200° C., and 0.15 parts of titanium diisopropylate bistriethanolaminate and 0.015 part of gallic acid were added to 100 parts of the monomers shown in Table 3. Then, the polycondensation reaction was carried out at 235° C. for 6 hours, and further the reaction was carried out at 235° C. and 8.0 kPa for 1 hour.

After cooling to 180° C., 0.015 parts of tert-butylcatechol was added to 100 parts of fumaric acid and trimellitic anhydride shown in Table 3 and the monomers shown in Table 3, the temperature was raised from 180° C. to 210° C. at 10° C./h, and the reaction time was adjusted to obtain the desired viscosity. After the reaction was completed, the resin composition was taken out from the vessel, cooled and pulverized to obtain a resin composition (A-14). Table 2 shows the physical properties.

TABLE 2

| Polyester | | | | | DSC peak |
|---|---|---|---|---|---|
| resin | | | | DSC peak | endothermic |
| composition | Tg | Tm | Acid value | temperature | quantity |
| No. | (° C.) | (° C.) | (mg KOH/g) | (° C.) | (J/g) |
| A-1 | 60.2 | 141.2 | 18.6 | 75.1 | 0.67 |
| A-2 | 65.1 | 144.6 | 17.6 | 75.9 | 0.62 |
| A-3 | 68.6 | 145.8 | 18.4 | 75.2 | 0.63 |
| A-4 | 64.8 | 142.1 | 19.8 | 75.2 | 0.64 |
| A-5 | 64.5 | 140.6 | 20.1 | 75.5 | 0.64 |
| A-6 | 64.8 | 138.5 | 19.8 | 75.4 | 0.65 |
| A-7 | 55.4 | 136.8 | 18.9 | 75.2 | 0.55 |
| A-8 | 59.5 | 133.4 | 21.3 | 75.6 | 0.39 |
| A-9 | 59.8 | 130.2 | 22.1 | 75.4 | 0.31 |
| A-10 | 54.9 | 119.8 | 14.9 | 75.5 | 0.68 |
| A-11 | 54.8 | 115.2 | 14.5 | 75.1 | 0.66 |
| A-12 | 60.3 | 140.2 | 18.9 | 75.2 | 0.65 |
| A-13 | 61.5 | 138.3 | 25.4 | — | — |
| A-14 | 55.9 | 120.1 | 20.8 | — | — |

TABLE 3

| | | | | | | | | | | | StBA resin | | | |
|---|---|---|---|---|---|---|---|---|---|---|---|---|---|---|
| Polyester | Polyester resin component charge composition (*1) | | | | | | | | | | component charge | | | |
| resin | | | 1,4- | | | | | | Long-chain | | composition (*2) | | | |
| composition | BPA- | BPA- | Butane | | | Dodecanedioic | Fumaric | | alkyl monomer | | | | Acrylic | PES/StAc |
| No. | PO | EO | diol | TPA | IPA | acid | acid | TMA | No. | mass % | St | BA | acid | ratio (*3) |
| A-1 | 80 | 20 | — | 67 | — | 7 | — | 15 | W-1 | 5.0 | 10 | 90 | — | 96/4 |
| A-2 | 80 | 20 | — | 74 | — | — | — | 15 | W-1 | 5.0 | 10 | 90 | — | 96/4 |
| A-3 | 99 | 1 | — | 74 | — | — | — | 15 | W-1 | 5.0 | 10 | 90 | — | 94/4 |
| A-4 | 80 | 20 | — | 74 | — | — | — | 15 | W-1 | 5.0 | 30 | 70 | — | 90/10 |
| A-5 | 80 | 20 | — | 74 | — | — | — | 15 | W-1 | 5.0 | 50 | 50 | — | 85/15 |
| A-6 | 80 | 20 | — | 74 | — | — | — | 15 | W-1 | 5.0 | 60 | 40 | — | 85/15 |
| A-7 | 80 | 20 | — | 74 | — | — | — | 15 | W-1 | 5.0 | 60 | 40 | — | 70/30 |
| A-8 | 80 | 20 | — | 74 | — | — | — | 15 | W-1 | 5.0 | 4 | 96 | — | 50/50 |
| A-9 | 80 | 20 | — | 74 | — | — | — | 15 | W-1 | 5.0 | 4 | 96 | — | 40/60 |
| A-10 | 50 | 50 | — | 5 | 80 | — | — | — | W-1 | 5.0 | 10 | 90 | — | 94/6 |
| A-11 | 50 | 50 | — | 5 | 80 | — | — | — | W-1 | 5.0 | 10 | 90 | — | 94/6 |
| A-12 | 50 | 50 | — | 64 | — | — | — | 25 | W-1 | 5.0 | 85 | 5 | 10 | 70/30 |
| A-13 | 30 | 20 | 50 | 60 | — | — | — | 20 | — | — | — | — | — | — |
| A-14 | 50 | 50 | — | 60 | — | — | 10 | 10 | — | — | 70 | 30 | — | 70/30 |

Abbreviations in Table 3 are as follows.
BPA-PO: propylene oxide adduct (2.3 mole addition) of bisphenol A
BPA-EO: ethylene oxide adduct (2.0 mole addition) of bisphenol A
TPA: terephthalic acid
IPA: isophthalic acid
TMA: trimellitic anhydride
St: Styrene
BA: Butyl acrylate
In the table, the numerical values of monomers other than the long-chain alkyl monomers represent mol parts.
*1: The mol part of the monomer indicates the ratio when the total amount of the monomers in the alcohol component (excluding the long-chain alkyl monomer) is 100 mol parts.
*2: The mol part of the monomer indicates the ratio when the total amount of the monomers in the vinyl polymer segment is 100 mol parts.
*3: The PES/StAc ratio is a polyester segment (excluding long-chain alkyl monomer)/vinyl polymer segment (mass basis) ratio

Polyester Resin Composition (B-1) Production Example

The starting monomers indicated in Table 4 were introduced in the blend amounts (mol parts) indicated in Table 4 into a reactor fitted with a nitrogen introduction line, a water separator, a stirrer, and a thermocouple, and 1.0 parts of dibutyltin oxide was then added as catalyst per 100 parts of the total amount of starting monomer. At this time, as a long-chain alkyl monomer, W-2 (UNILIN 700 (Toyo Petrolite Co., Ltd.) was used.

The temperature in the reactor was raised to 150° C. while stirring under a nitrogen atmosphere, and a polymerization was then run by distilling out water while heating from 150° C. to 200° C. at a ramp rate of 10° C./hour.

After reaching 200° C., the pressure in the reactor was reduced to 5 kPa or less and a polycondensation was run for 3 hours under conditions of 200° C. and 5 kPa or less.

The completion of the reaction was followed by removal from the vessel, cooling, and pulverization to obtain the polyester resin composition (B-1). The properties are given in Table 5.

Production Example of Polyester Resin Composition (B-2)

In addition to the alcohol components and the carboxylic acid components, other than adipic acid and trimellitic anhydride, that are shown in Table 4, 0.02 parts of tin (II) 2-ethylhexanoate and 0.025 parts of gallic acid relative to 100 parts of monomers in Table 4 were placed into a 10-liter four-necked flask equipped with a nitrogen introducing tube, a dehydration tube equipped with a fractionation tube through which hot water at 100° C. was flowing, a stirrer and a thermocouple, the flask was held at 180° C. for 1 hour in a nitrogen atmosphere, the temperature was thereafter raised from 180° C. to 230° C. at 10° C./h, and then a polycondensation reaction was performed at 230° C. for 6 hours.

After conducting the reaction at 230° C. and 8.0 kPa for 1 hour, trimellitic anhydride was further reacted at 210° C., and the reaction time was adjusted to obtain a desired viscosity. After the reaction was completed, the resin composition was taken out from the vessel, cooled and pulverized to obtain a resin composition (B-2). Table 5 shows the physical properties.

TABLE 4

| Polyester | Polyester resin component charge composition (*1) | | | | | | | | | |
|---|---|---|---|---|---|---|---|---|---|---|
| resin | | | | | | | | | Long-chain alkyl | |
| composition | BPA- | BPA- | | 1,4-Butane | | | Adipic | | monomer | |
| No. | PO | EO | EG | diol | TPA | IPA | acid | TMA | No. | mass % |
| B-1 | 41 | 37 | 22 | — | 85 | 1 | | | W-2 | 8 |
| B-2 | 30 | 20 | — | 50 | 60 | — | 4 | 7 | — | — |

Abbreviations in Table 4 are as follows.
BPA-PO: propylene oxide adduct (2.0 mole addition) of bisphenol A
BPA-EO: ethylene oxide adduct (2.0 mole addition) of bisphenol A
EG: ethylene glycol
TPA: terephthalic acid
IPA: isophthalic acid
TMA: trimellitic anhydride
In the table, the numerical values of monomers other than long-chain alkyl monomers represent mol parts.
*1: The mol part of the monomer indicates the ratio when the total amount of the monomers of the alcohol component (excluding the long-chain alkyl monomer) is 100 mol parts.

TABLE 5

| Polyester | | | | | DSC peak |
|---|---|---|---|---|---|
| resin | | | | DSC peak | endothermic |
| composition | Tg | Tm | Acid value | temperature | quantity |
| No. | (° C.) | (° C.) | (mg KOH/g) | (° C.) | (J/g) |
| B-1 | 58.3 | 95.6 | 7.5 | 105.3 | 3.22 |
| B-2 | 53.4 | 90.2 | 20.1 | — | — |

Production Example of Crystalline Polyester (C-1)

Ethylene glycol 100.0 mol parts

Tetradecanedioic acid 90.0 mol parts

Lauric acid 20.0 mol parts

A total of 0.2% by mass of dibutyltin oxide based on the above monomers and the total amount of the monomers was placed in a 10 L four-necked flask equipped with a nitrogen introducing tube, a dehydration tube, a stirrer and a thermocouple, and the reaction was performed at 180° C. for 4 hours. Then, the temperature was raised to 210° C. at 10° C./1 hour, the temperature was maintained at 210° C. for 8 hours, and then the reaction was performed at 8.3 kPa for 1 hour to obtain a crystalline polyester (C-1). Table 6 shows the physical properties.

Production Example of Crystalline Polyesters (C-2) to (C-11)

Resin compositions (C-2) to (C-11) were obtained in the same manner as in the Production Example of Crystalline Polyester (C-1) except that the monomer formulation shown in Table 6 was changed. Table 6 shows the physical properties.

TABLE 6

| Crystalline | | | | | | | |
|---|---|---|---|---|---|---|---|
| polyester | Alcohol component | | Acid component | | Terminal monomer | | DSC peak |
| composition | | Mol | | Mol | Monomer | Mol | temperature |
| No. | Monomer type | parts | Monomer type | parts | type | parts | (° C.) |
| C-1 | Ethylene glycol | 100.0 | Tetradecanedioic acid | 90.0 | Lauric acid | 20.0 | 88 |
| C-2 | 1,4-Butane diol | 100.0 | Dodecanedioic acid | 90.0 | Lauric acid | 20.0 | 70 |
| C-3 | 1,4-Butane diol | 100.0 | Dodecanedioic acid | 90.0 | — | — | 65 |
| C-4 | Ethylene glycol | 100.0 | Dodecanedioic acid | 90.0 | Lauric acid | 20.0 | 80 |
| C-5 | 1,4-Butane diol | 100.0 | Adipic acid | 90.0 | Lauric acid | 20.0 | 68 |
| C-6 | Ethylene glycol | 100.0 | Adipic acid | 90.0 | Lauric acid | 20.0 | 72 |
| C-7 | 1,6-Hexane diol | 100.0 | Tetradecanedioic acid | 90.0 | Lauric acid | 20.0 | 74 |
| C-8 | 1,4-Butane diol | 100.0 | Tetradecanedioic acid | 90.0 | Lauric acid | 20.0 | 70 |
| C-9 | Ethylene glycol | 100.0 | Dodecanedioic acid | 100.0 | — | — | 83 |
| C-10 | 1,6-Hexane diol | 100.0 | Sebacic acid | 100.0 | — | — | 68 |
| C-11 | Ethylene glycol | 100.0 | Sebacic acid | 100.0 | — | — | 48 |

Production Example of Magnetic Particle 1

### (1) Production of Core Particles

A total of 92 L of a ferrous sulfate aqueous solution having a Fe′ concentration of 1.60 mol/L and 88 L of a 3.50 mol/L sodium hydroxide aqueous solution were added and mixed and stirred. The pH of this solution was 6.5. While maintaining this solution at a temperature of 89° C. and a pH of from 9 to 12, 20 L/min of air was blown in to cause an oxidation reaction and generate core particles. When the ferrous hydroxide was completely consumed, the blowing of air was stopped and the oxidation reaction was terminated. The obtained core particles made of magnetite had an octahedral shape.

### (2) Formation of Coating Layer

After mixing 2.50 L of a 0.7 mol/L sodium silicate aqueous solution and 2.00 L of a 0.90 mol/L ferrous sulfate aqueous solution, 1.00 L of water was added to make 5.00 L of an aqueous solution that was added to the slurry after the reaction that included 13,500 g of core particles while maintaining pH at 7 to 9. Then, air was blown at 10 L/min until Fe′ in the slurry did not remain.

Subsequently, 0.70 L of a 1.50 mol/L aluminum sulfate aqueous solution and 2.00 L of a 0.90 mol/L ferrous sulfate aqueous solution were mixed, and then 1.00 L of water was added to make 5.00 L of an aqueous solution that was added to the slurry after the reaction that included core particles while maintaining pH at 7 to 9. Then, air was blown at 10 L/min until Fe′ in the slurry did not remain. The temperature of the slurry was maintained at 89° C. After mixing and stirring for 30 minutes, the slurry was filtered, washed and dried to obtain magnetic particles 1.

The magnetic particles 1 had octahedron shape, and the number average particle diameter (D1) of the primary particles of the magnetic particles 1 was 110 nm. Table 7 shows the physical properties of the obtained magnetic particles 1.

TABLE 7

| | Number average | | | | |
|---|---|---|---|---|---|
| | particle diameter of | | | | |
| Magnetic | primary particles | Shape | ESCA analysis results | | |
| particles | nm | — | Si | Al | Fe |
| Magnetic | 110 | Octahedron | 5.21 | 2.15 | 12.97 |
| particles 1 | | | | | |

Release Agents 1 to 4

The release agents shown in Table 8 were used.

TABLE 8

| Release agent | | Melting |
|---|---|---|
| No. | Product name | point |
| Release agent-1 | C105 (Sasol Wax GmbH) | 105° C. |
| Release agent-2 | FNP-90 (Nippon Seiro Co., Ltd.) | 90° C. |
| Release agent-3 | FT-80 (Nippon Seiro Co., Ltd.) | 85° C. |
| Release agent-4 | NP-105 (Mitsui Chemicals, Inc.) | 140° C. |

### Example 1

| | | |
|---|---|---|
| Polyester resin composition (A-1) | 100.0 | parts |
| Crystalline polyester (C-1) | 12.0 | parts |
| Magnetic particles 1 | 50.0 | parts |
| Release agent-1 | 2.0 | parts |
| Charge control agent (T-77, Hodogaya Chemical Co., Ltd.) | 1.0 | part |

The above materials were premixed with a Henschel mixer and then melt-kneaded at a preset temperature of 120° C. with a twin-screw kneading extruder (PCM-30 type manufactured by Ikegai Tekko KK).

The obtained kneaded product was cooled, coarsely pulverized with a hammer mill, and then annealed for 1 day at a temperature of 50° C. and a relative humidity of 95%.

Then, the coarsely pulverized product was pulverized with a mechanical pulverizer (T-250 manufactured by Turbo Kogyo Co., Ltd.), and the obtained finely pulverized powder was classified using a multi-division classifier utilizing the Coanda effect to obtain negatively chargeable toner particles having a weight average particle diameter (D4) of 7.0 μm.

A total of 1.0 part of hydrophobic silica fine particles 1 [BET specific surface area 150 m²/g, hydrophobized with 30 parts of hexamethyldisilazane (HMDS) and 10 parts of dimethyl silicone oil per 100 parts of silica fine particles] was externally added to 100 parts of toner particles and mixed with a Henschel mixer (FM-75 type manufactured by Nippon Coke Industry Co., Ltd.), followed by sieving with a mesh having an opening of 150 μm to obtain a toner (T-1). Table 9 shows the physical properties of the obtained toner (T-1).

The following evaluation was performed using the obtained toner.

### Test

The HP LaserJet Enterprise M609dn modified to have a process speed of 450 mm/sec was used in consideration of the future speedup of the printers. Table 10 shows the results of the evaluation.

Low-Temperature Fixability 1: Rubbing Density Reduction Rate

A rubbing density reduction rate was determined using an external fixing device obtained by taking out the fixing device of the above evaluation machine, enabling arbitrary setting of the temperature of the fixing device, and modifying so that the process speed was 450 mm/sec.

Using the above apparatus, an unfixed image with a toner laid-on level per unit area set to 0.5 mg/cm² was passed through the fixing device set to 200° C. under a low-temperature and low-humidity environment (temperature 15° C., humidity 10% RH). “PB PAPER” (manufactured by Canon Marketing Japan Co., Ltd., basis weight 66 g/cm², letter) was used as the evaluation paper. The obtained fixed image was rubbed with a sillbon paper applied with a load of 4.9 kPa (50 g/cm²), and evaluated by the reduction rate (%) of the image density from that before to that after the rubbing. The image density was measured with a Macbeth densitometer (manufactured by Macbeth Co.), which is a reflection densitometer, by using an SPI filter. Ranks A and B were considered to be satisfactory.

A: the reduction rate of the image density is less than 10.0%.
B: the reduction rate of the image density is from 10.0% to less than 15.0%.
C: the reduction rate of the image density is from 15.0% to less than 20.0%.
D: the reduction rate of image density is 20.0% or more.

Low-Temperature Fixing Property 2: Missing Fixing Points

Missing fixing points were evaluated using an external fixing device obtained by taking out the fixing device of the above evaluation machine, enabling arbitrary setting of the temperature of the fixing device, and modifying so that the process speed was 480 mm/sec.

Using the above apparatus, an unfixed all-surface solid image with a toner laid-on level per unit area set to 1.0 mg/cm² was passed through the fixing device set to 200° C. under a low-temperature and low-humidity environment (temperature 15° C., humidity 10% RH). “PB PAPER” (manufactured by Canon Marketing Japan Co., Ltd., basis weight 66 g/cm², letter) was used as the evaluation paper.

By visually confirming the obtained image, the number of places where the toner was missing due to insufficient toner fixing was counted, and the missing fixing points were evaluated according to the following criteria. Ranks A and B were considered to be satisfactory.

A: The number of missing spots is less than 3.
B: The number of missing spots is from 3 to less than 6.
C: The number of missing spots is from 6 to less than 9.
D: The number of missing spots is 9 or more.

Solid Image Density Unevenness

The solid image density unevenness was evaluated using an external fixing device obtained by taking out the fixing device of the above evaluation machine, enabling arbitrary setting of the temperature of the fixing device, and modifying so that the process speed was 480 mm/sec. An unfixed all-surface solid image with a toner laid-on level per unit area set to 1.0 mg/cm² was passed through the fixing device set to 200° C. under a high-temperature and high-humidity environment (temperature 32.5° C., humidity 85% RH).

A recording medium of a Vitality type (manufactured by Xerox, basis weight 75 g/cm², letter) which had an Sa (arithmetic mean height) of 3.00 μm or more in the below-described surface roughness measurement was used as evaluation paper for the evaluation.

The density of the obtained image was randomly measured at 20 points, and the evaluation was performed by the difference between the maximum value and the minimum value of the measured density. The image density was evaluated according to the following criteria by changing the measurement spot diameter of a Macbeth densitometer (manufactured by Macbeth Co.), which is a reflection densitometer, to 3 mm, and using an SPI filter. Ranks A and B were considered to be satisfactory.

A: The density difference is less than 0.10.
B: The density difference is from 0.10 to less than 0.20.
C: The density difference is from 0.20 to less than 0.30.
D: The density difference is 0.30 or more.

Evaluation of Fogging

The operation of outputting an image with a print percentage of 1% was repeated in a high-temperature and high-humidity environment (temperature 32° C., relative humidity 80%), and once the output number reached 500, the system was allowed to stand overnight. After that, the process of outputting 500 sheets and allowing to stand overnight as described above was repeated, and finally, 5000 images were outputted and evaluated by the following method. “PB PAPER” (manufactured by Canon Marketing Japan Co., Ltd, basis weight 66 g/cm², letter) was used as the evaluation paper.

In the above image output test, images with a white background were outputted one by one at a time. Then, with respect to all the images having the white background portions, a fogging density (%) (=Dr (%)−Ds (%)) was calculated from the difference between the whiteness (reflectance Ds (%)) of the white background portion of the image having the white background portion and the whiteness (average reflectance Dr (%)) of the transfer paper. The whiteness was measured by “REFLECTMETER MODEL TC-6DS” (manufactured by Tokyo Denshoku Co., Ltd.). An amberlite filter was used as the filter. The following ranking was performed for the prints with the worst fogging density. Ranks from A to C were considered to be satisfactory.

A: The fogging density is less than 2.5%.
B: The fogging density is from 2.5% to less than 4.5%.
C: The fogging density is from 4.5% to less than 6.5%.
D: The fogging density is 6.5% or more.

Image Density after Durability Testing

The evaluation was performed using the modified machine described above. The toner in the cartridge was emptied out and the cartridge was then filled with 700 g of toner (T-1).

A test was run in which 25000 prints were output, using 2 prints/1 job of a horizontal line pattern having a print percentage of 1.5%, in a mode in which the machine was set to temporarily stop between jobs and then start the next job. The evaluation was performed in a high-temperature, high-humidity environment (temperature=32.5° C., humidity=85% RH). PB PAPER (Canon Marketing Japan Inc., areal weight=66 g/cm², letter) was used for the evaluation paper.

At 25001st print, a check image was output having a total of nine 5 mm×5 mm solid black patch images, at 3 locations, i.e., left, right, and center, with a 5 mm leading edge margin and 5 mm right and left margins, and these at 3 locations on a 30-mm interval in the length direction.

The image density was measured at the nine solid black patch image regions of the check image and the average value was determined. The image density was measured with a MacBeth densitometer (GretagMacbeth GmbH), which is a reflection densitometer, using an SPI filter, and the evaluation was made using the following criteria. Ranks A and B were considered to be satisfactory.

A: The mage density is 1.30 or higher.
B: The image density is from 1.10 to less than 1.30.
C: The image density is from 0.90 to less than 1.10.
D: The image density is less than 0.90.

Storability Under Severe Conditions

The toner in the cartridge was emptied out followed by filling with 700 g of toner (T-1). The toner was first brought into a consolidated fill condition by tapping 300 times with the drive side down. Then, rigorous evaluation of storability was performed under severe conditions by holding the cartridge, with the drive side down, for 90 days in a severe environment (temperature=40° C., humidity=95% RH).

The cartridge was subsequently removed, and an image output test was run using the modified machine described above in a high-temperature, high-humidity environment (temperature=32.5° C., humidity=85% RH) and the storability under severe conditions was evaluated.

For the image output test, a test was first run in which 20000 prints were output, using 2 prints/1 job of a horizontal line pattern having a print percentage of 2.0%, in a mode in which the machine was set to temporarily stop between jobs and then start the next job. This was followed by the output of a check image in the same environment.

For the check image, a 200 mm×280 mm halftone image (dot print percentage=23%) was output and the presence/absence of the production of vertical streaks in the check image was visually inspected and evaluated based on the following criteria. Ranks A and B were considered to be satisfactory.

A: No streaks are produced.
B: from 1 to 5 streaks of less than 1 mm are produced, and a streak of 1 mm or larger is not produced.
C: 6 or more streaks of less than 1 mm are produced, and a streak of 1 mm or larger is not produced.
D: A streak of 1 mm or larger is produced.

### Examples 2 to 18

Toners (T-2) to (T-18) were obtained in the same manner as in Example 1 except that the formulations shown in Table 10 were used. Table 9 shows the physical properties.

Further, Table 11 shows the results of evaluation performed in the same manner as in Example 1.

### Comparative Examples 1 and 2

Toners (T-19) to (T-20) were obtained in the same manner as in Example 1 except that the formulations shown in Table 10 were used. Table 9 shows the physical properties.

Further, Table 11 shows the results of evaluation performed in the same manner as in Example 1.

### Comparative Example 3 and Comparative Example 6

Toners (T-21) and (T-24) were obtained in the same manner as in Example 1 except that the formulations shown in Table 10 were changed and the annealing treatment was not performed. Table 9 shows the physical properties.

Further, Table 11 shows the results of evaluation performed in the same manner as in Example 1.

### Comparative Example 4

### (Preparation of Crystalline Polyester Resin-Dispersed Liquid)

A total of 100 g of the crystalline polyester (C-9) and 400 g of ethyl acetate were placed in a metal 2 L vessel, heated and dissolved at 75° C., and then rapidly cooled at a rate of 27° C./min in an ice water bath. To this, 500 ml of glass beads (3 mmd)) was added, and pulverization was performed for 10 hours with a batch-type sand mill device (manufactured by Kanpe Hapio Co., Ltd.) to obtain “Crystalline Polyester-Dispersed Liquid 1”.

Synthesis of Amorphous Polyester (Low-Molecular-Weight Amorphous Polyester) Resin

A total of 229 parts of ethylene oxide (2 mole) adduct of bisphenol A, 529 parts of propylene oxide (3 mole) adduct of bisphenol A, 100 parts of isophthalic acid, 108 parts of terephthalic acid, 46 parts of adipic acid, and 2 parts of dibutyltin oxide were placed in a 5 liter four-necked flask equipped with a nitrogen introduction tube, a dehydration tube, a stirrer and a thermocouple. The components were reacted at 230° C. under normal pressure for 10 hours and further reacted under reduced pressure of from 10 mm Hg to 15 mm Hg for 5 hours, and then 30 parts of trimellitic anhydride was placed into the reaction vessel and reacted at 180° C. under normal pressure for 3 hours to obtain “Amorphous Polyester 1”.

The “Amorphous Polyester 1” had a number average molecular weight of 1800, a weight average molecular weight of 5500, a Tg of 50° C., and an acid value of 20 mg KOH/g.

Synthesis of Polyester Prepolymer (Binder Resin Precursor)

A total of 682 parts of ethylene oxide (2 mole) adduct of bisphenol A, 81 parts of propylene oxide (2 mole) adduct of bisphenol A, 283 parts of terephthalic acid, 22 parts of trimellitic anhydride and 2 parts of dibutyltin oxide were placed in a reaction vessel equipped with a cooling tube, a stirrer, and a nitrogen introduction tube. The components were reacted at 230° C. under normal pressure for 8 hours and further reacted under reduced pressure of from 10 mm Hg to 15 mm Hg for 5 hours to obtain “Intermediate Polyester 1”.

The “Intermediate Polyester 1” had a number average molecular weight of 2100, a weight average molecular weight of 9500, a Tg of 55° C., an acid value of 0.5 mg KOH/g, and a hydroxyl value of 51 mgKOH/g.

Next, 410 parts of the “Intermediate Polyester 1”, 89 parts of isophorone diisocyanate, and 500 parts of ethyl acetate were placed in a reaction vessel equipped with a cooling pipe, a stirrer and a nitrogen introduction pipe, and the components were reacted at 100° C. for 5 hours to obtain “Prepolymer 1”. The amount of free isocyanate in “Prepolymer 1” was 1.53% by mass.

Synthesis of Ketimine

A total of 170 parts of isophoronediamine and 75 parts of methyl ethyl ketone were charged in a reaction vessel in which a stirring bar and a thermometer were set, and the reaction was performed at 50° C. for 5 hours to obtain “Ketimine Compound 1”.

The “Ketimine Compound 1” had an amine value of 418 mg KOH/g.

Synthesis of Master Batch (MB)

A total of 1200 parts of water, 1200 parts of the magnetic particles 1, and 1200 parts of the amorphous polyester resin 1 were added and mixed with a Henschel mixer (manufactured by Mitsui Mining Co., Ltd.), and the mixture was kneaded at 150° C. for 30 minutes by using a two-roll mill and then rolled and cooled, and pulverized with a pulverizer to obtain “Master Batch 1”.

Preparation of Oil Phase

A total of 378 parts of the “Amorphous Polyester 1”, 110 parts of carnauba WAX, 22 parts of CCA (metal salicylate complex E-84: Orient Chemical Industries Co., Ltd.), and 947 parts of ethyl acetate were charged into a vessel in which a stirring bar and a thermometer were set, the temperature was raised to 80° C. under stirring, the temperature was kept at 80° C. for 5 hours, and then cooling was performed to 30° C. in 1 hour. Next, 690 parts of the “Master Batch 1” and 500 parts of ethyl acetate were charged into the vessel and mixed for 1 hour to obtain “Raw Material Solution 1”.

A total of 1324 parts of the “Raw Material Solution 1” was transferred to a vessel, and using a bead mill (ULTRA VISCO MILL, manufactured by AIMEX Co., Ltd.), magnetic particles 1 and WAX were dispersed at a liquid feeding speed of 1 kg/hr, a disk peripheral speed of 6 m/sec, and a 0.5 mm zirconia bead filling ratio of 80% by volume under three-pass conditions. Next, 1042.3 parts of a 65% ethyl acetate solution of the “Amorphous Polyester 1” was added, and the mixture was passed through the bead mill under the above conditions for 1 pass to obtain “Pigment/WAX-Dispersed Liquid 1”. The solid fraction concentration (130° C., 30 minutes) of the “Pigment/WAX-Dispersed Liquid 1” was 50%.

Synthesis of Organic Fine Particle Emulsion

A total of 683 parts of water, 11 parts of sodium salt of sulfuric acid ester of acid ethylene oxide adduct of methacrylic acid (ELEMINOL RS-30: manufactured by Sanyo Chemical Industries, Ltd.), 138 parts of styrene, 138 parts of methacrylic acid, and 1 part of ammonium persulfate were charged in a reaction vessel in which a stirring bar and a thermometer were set, and stirred at 400 rpm for 15 minutes to obtain a white emulsion. The temperature in the system was raised to 75° C. by heating, and the reaction was carried out for 5 hours.

Further, 30 parts of a 1% ammonium persulfate aqueous solution was added followed by maturing at 75° C. for 5 hours, and an aqueous dispersion liquid of a vinyl resin (copolymer of styrene with methacrylic acid and sodium salt of sulfuric acid ester of ethylene oxide adduct of methacrylic acid) “Fine Particle-Dispersed Liquid 1” was obtained. The volume average particle diameter of the “Fine Particle-Dispersed Liquid 1” measured by LA-920 was 0.14 μm. A part of the “Fine Particle-Dispersed Liquid 1” was dried to isolate a resin component.

Preparation of Aqueous Phase

A total of 990 parts of water, 83 parts of the “Fine Particle-Dispersed Liquid 1”, 37 parts of a 48.5% aqueous solution of sodium dodecyldiphenyl ether disulfonate (ELEMINOL MON-7: manufactured by Sanyo Chemical Industries, Ltd.), and 90 parts of ethyl acetate were mixed and stirred to obtain a milky white liquid. The liquid was designated as “Aqueous Phase 1”.

Emulsification/Solvent Removal

A total of 664 parts of the “Pigment/WAX-Dispersed Liquid 1”, 109.4 parts of the “Prepolymer 1”, 73.9 parts of the “Crystalline Polyester-Dispersed Liquid 1”, and 4.6 parts of the “Ketimine Compound 1” were placed in a vessel and mixed for 1 minute at 5000 rpm with a TK Homomixer (manufactured by Tokushu Kika Kogyo Co., Ltd.). Then, 1200 parts of the “Aqueous Phase 1” was added to the vessel, and mixing was performed for 20 minutes at a rotation speed of 13,000 rpm with the TK Homomixer to obtain “Emulsified Slurry 1”.

The “Emulsified Slurry 1” was placed in a vessel equipped with a stirrer and a thermometer, desolvated at 30° C. for 8 hours, and then matured at 45° C. for 4 hours to obtain “Dispersed Slurry 1”.

Washing/Drying

After 100 parts of the “Dispersed Slurry 1” was vacuum filtered, the following operations (1) to (4) were performed twice to obtain “Filter Cake 1”:

(1) 100 parts of ion-exchanged water is added to the filter cake, followed by mixing with the TK Homomixer (rotation speed 12,000 rpm for 10 minutes) and then filtering;
(2) 100 parts of a 10% sodium hydroxide aqueous solution is added to the filter cake of (1), followed by mixing with the TK Homomixer (rotation speed 12,000 rpm for 30 minutes) and then vacuum filtering;
(3) 100 parts of 10% hydrochloric acid is added to the filter cake of (2), followed by mixing with the TK Homomixer (rotation speed 12,000 rpm for 10 minutes) and then filtering.
(4) 300 parts of ion-exchanged water is added to the filter cake of (3), followed by mixing with the TK Homomixer (rotation speed 12,000 rpm for 10 minutes) and then filtering.

The “Filter Cake 1” was dried at 45° C. for 48 hours by a circulating air dryer, and toner particles were obtained by sieving with a mesh having an opening of 75 μm.

A total of 1.0 part of hydrophobic silica fine particles 1 per 100 parts of toner particles [BET specific surface area 150 m²/g, hydrophobized with 30 parts of hexamethyldisilazane (HMDS) and 10 parts of dimethyl silicone oil per 100 parts of silica fine particles] was externally added to 100 parts of toner particles and mixed with a Henschel mixer (FM-75 type, manufactured by Nippon Coke Industry Co., Ltd.), and sieving was performed with a mesh having an opening of 150 μm to obtain a toner (T-22). Table 9 shows the physical properties.

### Comparative Example 5

### Synthesis of Non-Linear Amorphous Polyester

3-Methyl-1,5-pentanediol, adipic acid and trimethylolpropane were placed in a reaction vessel equipped with a cooling pipe, a stirrer and a nitrogen introducing pipe to obtain a molar ratio [OH]/[COOH] of hydroxyl groups to carboxyl groups of 1.1. At this time titanium tetraisopropoxide was added at 1000 ppm with respect to all the monomers to obtain 1.5 mol % of trimethylolpropane with respect to all the monomers.

Next, the temperature was raised to 200° C. in about 4 hours and then to 230° C. in 2 hours, and the reaction was continued until the runoff water disappeared. Further, the reaction was performed under a reduced pressure of from 10 mm Hg to 15 mm Hg for 5 hours to obtain a non-linear amorphous polyester having a hydroxyl group.

Synthesis of Linear Amorphous Polyester

Ethylene oxide (2 mole) adduct of bisphenol A, propylene oxide (2 mole) adduct of bisphenol A, isophthalic acid, and adipic acid were placed in a reaction vessel equipped with a nitrogen introduction tube, a dehydration tube, a stirrer and a thermocouple to obtain a molar ratio [OH]/[COOH] of hydroxyl groups of carboxyl groups of 1.2.

At this time, the diol was composed of 80 mol % of ethylene oxide (2 mole) adduct of bisphenol A and 20 mol % of propylene oxide (2 mole) adduct of bisphenol A, and the dicarboxylic acid was composed of 80 mol % of isophthalic acid and 20 mol % of adipic acid, and titanium tetraisopropoxide was added in an amount of 500 ppm based on all the monomers.

Next, the components were reacted at 230° C. for 8 hours and then for 4 hours under reduced pressure of from 10 mm Hg to 15 mm Hg. Further, trimellitic anhydride was added to obtain 1 mol % with respect to all the monomers, and the reaction was then performed at 180° C. for 3 hours to obtain a linear amorphous polyester. The weight average molecular weight was 5500 and the glass transition point was 50° C.

Preparation of Master Batch

A total of 1200 parts of water, 500 parts of carbon black Printex 35 (manufactured by Degussa Corp.) having a DBP oil absorption quantity of 42 mL/100 mg and a pH of 9.5, and 500 parts of the linear amorphous polyester were mixed using a Henschel mixer (manufactured by Mitsui Mining Co., Ltd.), and then kneaded for 30 minutes at 150° C. by using a two-roll mill. Next, after rolling and cooling, the mixture was pulverized using a pulverizer to obtain a master batch.

Preparation of Release Agent-Dispersed Liquid

A total of 50 parts of paraffin wax HNP-9 (manufactured by Nippon Seiro Co., Ltd.) having a melting point of 75° C. and 450 parts of ethyl acetate were placed into a vessel in which a stirring bar and a thermometer were set, and the temperature was raised to 80° C. under stirring and held for 5 hours. Next, after cooling to 30° C. for 1 hour, dispersion was performed using a bead mill ULTRA VISCO MILL (manufactured by AIMEX Co., Ltd.) at a liquid feeding speed of 1 kg/h, a disk peripheral speed of 6 m/sec, and a filling ratio of zirconia beads having a diameter of 0.5 mm of 80% by volume under three-pass conditions to obtain a release agent-dispersed liquid.

Preparation of Crystalline Polyester-Dispersed Liquid

A total of 50 parts of the crystalline polyester (C-10) and 450 parts of ethyl acetate were placed into a vessel in which a stirring bar and a thermometer were set, and the temperature was raised to 80° C. under stirring and held for 5 hours. Next, after cooling to 30° C. for 1 hour, dispersion was performed using a bead mill ULTRA VISCO MILL (manufactured by AIMEX Co., Ltd.) at a liquid feeding speed of 1 kg/h, a disk peripheral speed of 6 m/sec, and a filling ratio of zirconia beads having a diameter of 0.5 mm of 80% by volume under three-pass conditions to obtain a crystalline polyester-dispersed liquid.

Preparation of Oil Phase

A total of 50 parts of the release agent-dispersed liquid, 200 parts of the non-linear amorphous polyester, 500 parts of the crystalline polyester-dispersed liquid, 700 parts of the linear amorphous polyester, 50 parts of the master batch, and 2 parts of the ketimine compound 1 were placed in a vessel and then mixed at 5000 rpm for 60 minutes using the TK Homomixer (manufactured by Tokushu Kika Kogyo Co., Ltd.) to obtain an oil phase.

Preparation of Aqueous Dispersion of Vinyl Resin

A total of 683 parts of water, 11 parts of sodium salt of sulfuric acid ester of ethylene oxide adduct of methacrylic acid (ELEMINOL RS-30: manufactured by Sanyo Chemical Industries, Ltd.), 138 parts of styrene, 138 parts of methacrylic acid, and 1 part of ammonium persulfate were charged in a reaction tank in which a stirring bar and a thermometer were set, followed by stirring at 400 rpm for 15 minutes. Next, the temperature was raised to 75° C., the reaction was carried out for 5 hours, and thereafter 30 parts of a 1 mass % ammonium persulfate aqueous solution was added and maturing was performed at 75° C. for 5 hours to obtain an aqueous dispersion of vinyl resin.

The volume average particle diameter of the aqueous dispersion of vinyl resin measured by the laser diffraction/scattering particle size distribution measuring device LA-920 (manufactured by HORIBA) was 0.14 μm.

Preparation of Aqueous Phase

A total of 990 parts of water, 83 parts of the aqueous dispersion of vinyl resin, 37 parts of a 48.5 mass % aqueous solution of sodium dodecyldiphenyl ether disulfonate (ELEMINOL MON-7: manufactured by Sanyo Chemical Industries, Ltd.), and 90 parts of ethyl acetate were mixed and stirred to obtain an aqueous phase.

Emulsification/Solvent Removal

A total of 1200 parts of the aqueous phase was added to a vessel including 1052 parts of the oil phase, and the components were mixed at 13,000 rpm for 20 minutes using the TK Homomixer (manufactured by Tokushu Kika Kogyo Co., Ltd.) to obtain an emulsified slurry.

The emulsified slurry was placed in a vessel equipped with a stirrer and a thermometer, desolvated at 30° C. for 8 hours, and then matured at 45° C. for 4 hours to obtain a dispersed slurry.

Washing/Drying

A total of 100 parts of the dispersed slurry was vacuum filtered. The obtained filter cake was subjected twice to the following operations (1) to (4):

(1) 100 parts of ion-exchanged water is added to the filter cake, followed by mixing with the TK Homomixer (manufactured by Tokushu Kika Kogyo Co., Ltd.) at a rotation speed or 12,000 rpm for 10 minutes and then filtering;
(2) 100 parts of a 10% by mass sodium hydroxide aqueous solution is added to the filter cake of (1), followed by mixing with the TK Homomixer (manufactured by Tokushu Kika Kogyo Co., Ltd.) at a rotation speed or 12,000 rpm for 30 minutes and then vacuum filtering;
(3) 100 parts of 10% by mass hydrochloric acid is added to the filter cake of (2), followed by mixing with the TK Homomixer (manufactured by Tokushu Kika Kogyo Co., Ltd.) at a rotation speed or 12,000 rpm for 10 minutes and then filtering.
(4) 300 parts of ion-exchanged water is added to the filter cake of (3), followed by mixing with the TK Homomixer (manufactured by Tokushu Kika Kogyo Co., Ltd.) at a rotation speed or 12,000 rpm for 10 minutes and then filtering.

The obtained filter cake was dried at 45° C. for 48 hours by a circulating air dryer, and base toner particles were obtained by sieving with a mesh having an opening of 75 μm.

The operation of mixing 100 parts of the base toner particles and 1.0 part of hydrophobic silica HDK-2000 (manufactured by Wacker Chemie AG) with a Henschel mixer (manufactured by Mitsui Mining Co., Ltd.) at a peripheral speed of 30 m/s for 30 sec and then allowing the mixture to stand for 1 minute was repeated five times, and the mixture was thereafter sieved with a mesh having an opening of 35 μm to obtain a toner (T-23). Table 9 shows the physical properties.

TABLE 9

| | | Storage elastic modulus G′ | | | | | | | | | | | | | | | |
|---|---|---|---|---|---|---|---|---|---|---|---|---|---|---|---|---|---|
| | | | | | THF- | | | | | | | | | | | | |
| | | | | | insoluble | | | | | DSC | | | | | | | |
| | | Toner | Toner | (dG′)/ | matter | | | | | measurement | | | Flash DSC | | | | |
| | | (80° C.) × | (120° C.) × | (dT) | (120° C.) × | | | | | Toner | | | measurement | | | | |
| Toner | D4 | 10⁴ | 10³ | LM × | 10⁴ | S₂/S₁ × | | | | Tg | | | Tg1 | Tg1 − Tg2 | T1 | T2 | |
| No. | μm | [Pa] | [Pa] | 10⁵ | [Pa] | 1/R₁ | α | β | α − β | (° C.) | X | Y | (° C.) | (° C.) | (° C.) | (° C.) | T1 − T2 |
| 1 | 7.0 | 10 | 6.1 | −54 | 47 | 0.16 | 43.1 | 13.2 | 29.9 | 58 | 1 | 2 | 70 | 25 | 110 | 88 | 22 |
| 2 | 7.0 | 10 | 6.0 | −55 | 47 | 0.16 | 42.8 | 13.3 | 29.5 | 58 | 1 | 2 | 70 | 25 | 110 | 70 | 40 |
| 3 | 7.0 | 10 | 6.1 | −54 | 47 | 0.17 | 42.7 | 13.1 | 29.6 | 58 | 1 | 2 | 70 | 25 | 110 | 65 | 45 |
| 4 | 7.0 | 9.1 | 6.2 | −60 | 47 | 0.17 | 43.1 | 13.0 | 30.1 | 55 | 1 | 2 | 65 | 30 | 108 | 80 | 28 |
| 5 | 7.0 | 12 | 8.9 | −61 | 48 | 0.17 | 42.9 | 13.1 | 29.8 | 62 | 1 | 2 | 85 | 30 | 116 | 80 | 36 |
| 6 | 7.0 | 10 | 6.0 | −55 | 48 | 0.17 | 42.2 | 13.2 | 29.0 | 58 | 1 | 2 | 70 | 25 | 110 | 68 | 42 |
| 7 | 7.0 | 9.1 | 6.1 | −54 | 47 | 0.16 | 43.5 | 13.1 | 30.4 | 55 | 1 | 2 | 65 | 20 | 109 | 72 | 37 |
| 8 | 7.0 | 15 | 12 | −18 | 47 | 0.17 | 42.8 | 12.7 | 30.1 | 63 | 1 | 2 | 85 | 7 | 124 | 74 | 50 |
| 9 | 7.0 | 15 | 12 | −18 | 48 | 0.17 | 42.7 | 13.1 | 29.6 | 63 | 2 | 2 | 85 | 7 | 124 | 74 | 50 |
| 10 | 7.0 | 15 | 12 | −18 | 48 | 0.17 | 30.5 | 13.3 | 17.2 | 63 | 2 | 2 | 85 | 7 | 124 | 74 | 50 |
| 11 | 7.0 | 12 | 8.9 | −18 | 10 | 0.19 | 25.1 | 13.3 | 11.8 | 63 | 2 | 2 | 85 | 7 | 117 | 74 | 43 |
| 12 | 7.0 | 12 | 8.9 | −18 | 3.3 | 0.21 | 20.1 | 13.2 | 6.9 | 62 | 2 | 2 | 85 | 7 | 117 | 74 | 43 |
| 13 | 7.0 | 15 | 8.9 | −12 | 3.3 | 0.19 | 19.9 | 12.1 | 7.8 | 55 | 2 | 2 | 65 | 7 | 112 | 74 | 38 |
| 14 | 7.0 | 17 | 8.9 | −12 | 10 | 0.18 | 38.6 | 9.4 | 29.2 | 58 | 2 | 2 | 70 | 7 | 116 | 70 | 46 |
| 15 | 7.0 | 19 | 8.9 | −12 | 10 | 0.18 | 37.1 | 8.7 | 28.4 | 58 | 2 | 2 | 70 | 7 | 117 | 70 | 47 |
| 16 | 7.0 | 12 | 2.1 | −18 | 40 | 0.20 | 22.8 | 5.5 | 17.3 | 55 | 2 | 2 | 65 | 7 | 103 | 74 | 29 |
| 17 | 7.0 | 10 | 1.7 | −18 | 20 | 0.22 | 21.0 | 4.1 | 16.9 | 55 | 2 | 2 | 65 | 7 | 102 | 74 | 28 |
| 18 | 7.0 | 15 | 2.1 | −10 | 20 | 0.21 | 21.2 | 4.2 | 17.0 | 55 | 2 | 2 | 65 | 7 | 103 | 74 | 29 |
| 19 | 7.0 | 24 | 1.3 | −10 | 20 | 0.26 | 12.8 | 3.2 | 9.6 | 50 | 2 | 2 | 60 | 7 | 100 | 74 | 26 |
| 20 | 7.0 | 27 | 20 | −8.0 | 60 | 0.22 | 45.1 | 35.6 | 9.5 | 63 | 2 | 2 | 85 | 7 | 137 | 74 | 63 |
| 21 | 7.0 | 19 | 1.8 | −7.0 | 3.0 | 0.27 | 16.5 | 10.3 | 6.2 | 45 | 2 | 2 | 55 | 3 | 103 | 83 | 20 |
| 22 | 7.0 | 18 | 3.4 | −6.5 | 10 | 0.24 | 15.1 | 6.7 | 8.4 | 55 | 1 | 2 | 65 | 3 | 105 | 83 | 22 |
| 23 | 7.0 | 3.0 | 8.6 | −4.1 | 20 | 0.23 | 31.2 | 25.0 | 6.2 | 45 | 1 | 2 | 55 | 3 | 113 | 67 | 46 |
| 24 | 7.0 | 15 | 3.0 | −7.0 | 3.5 | 0.26 | 20.4 | 12.5 | 7.9 | 43 | 2 | 2 | 55 | 3 | 106 | 48 | 58 |

In the table, (dG′)/(dT)LM denotes local minimum value of (dG′)/(dT), α denotes Ethyl acetate-insoluble matter α (% by mass), β denotes THF-insoluble matter β (% by mass), X denotes Cold crystallization peak X, and Y denotes Endothermic peak Y.

TABLE 10

| | Resin | | Resin | | Crystalline | | Magnetic | | |
|---|---|---|---|---|---|---|---|---|---|
| Toner | composition A | | composition B | | polyester C | | particles -1 | Release agent | |
| No. | No. | parts | No. | parts | No. | parts | parts | No. | parts |
| 1 | A-1 | 100 | — | | C-1 | 12 | 50 | Release agent -1 | 2 |
| 2 | A-1 | 100 | — | | C-2 | 12 | 50 | Release agent -2 | 2 |
| 3 | A-1 | 100 | — | | C-3 | 12 | 50 | Release agent -3 | 2 |
| 4 | A-1 | 100 | — | | C-4 | 12 | 50 | Release agent -1 | 2 |
| 5 | A-2 | 100 | — | | C-4 | 12 | 50 | Release agent -1 | 2 |
| 6 | A-3 | 100 | — | | C-5 | 12 | 50 | Release agent -2 | 2 |
| 7 | A-3 | 100 | — | | C-6 | 12 | 50 | Release agent -2 | 2 |
| 8 | A-2 | 100 | — | | C-7 | 12 | 50 | Release agent -2 | 2 |
| 9 | A-2 | 100 | — | | C-7 | 12 | 50 | Release agent -1 | 2 |
| 10 | A-4 | 100 | — | | C-7 | 12 | 50 | Release agent -1 | 2 |
| 11 | A-5 | 100 | — | | C-7 | 12 | 50 | Release agent -1 | 2 |
| 12 | A-6 | 100 | — | | C-7 | 12 | 50 | Release agent -1 | 2 |
| 13 | A-7 | 100 | — | | C-7 | 12 | 50 | Release agent -1 | 2 |
| 14 | A-8 | 100 | — | | C-8 | 12 | 50 | Release agent -1 | 2 |
| 15 | A-9 | 100 | — | | C-8 | 12 | 50 | Release agent -1 | 2 |
| 16 | A-10 | 100 | — | | C-7 | 12 | 50 | Release agent -1 | 2 |
| 17 | A-11 | 100 | — | | C-7 | 12 | 50 | Release agent -1 | 2 |
| 18 | A-11 | 100 | — | | C-7 | 8 | 50 | Release agent -1 | 2 |
| 19 | A-11 | 70 | B-1 | 30 | C-7 | 8 | 50 | Release agent -1 | 2 |
| 20 | A-12 | 100 | — | | C-7 | 8 | 50 | Release agent -1 | 2 |
| 21 | A-13 | 90 | — | | C-9 | 10 | 50 | Release agent -4 | 2 |
| 22 | See the description | | | | | | | | |
| 23 | | | | | | | | | |
| 24 | A-14 | 60 | B-2 | 30 | C-11 | 10 | 50 | Release agent -4 | 2 |

TABLE 11

| | | Low-temperature fixability | | | | | |
|---|---|---|---|---|---|---|---|
| | | Rubbing density | | Solid image | | | Storability |
| Example | Toner | reduction rate | Missing | density | | Image density | under severe |
| No. | No. | (%) | points | unevenness | Fogging | after durability | environment |
| 1 | 1 | A(3) | A(0) | A(0.03) | A(2.0) | A(1.41) | A |
| 2 | 2 | A(3) | A(0) | A(0.03) | A(2.1) | A(1.40) | A |
| 3 | 3 | A(3) | A(0) | A(0.05) | A(2.0) | A(1.30) | A |
| 4 | 4 | A(3) | A(0) | A(0.05) | A(1.9) | A(1.42) | B(2 Stripes) |
| 5 | 5 | A(6) | A(0) | A(0.05) | A(2.0) | A(1.40) | A |
| 6 | 6 | A(3) | A(0) | A(0.05) | A(2.1) | A(1.30) | A |
| 7 | 7 | A(3) | A(0) | A(0.05) | A(2.0) | A(1.41) | B(4 Stripes) |
| 8 | 8 | B (10) | B (3) | A(0.05) | A(2.0) | A(1.30) | A |
| 9 | 9 | B (10) | B (3) | A(0.05) | B(3.0) | A(1.31) | A |
| 10 | 10 | B (10) | B (3) | A(0.05) | B(3.1) | A(1.30) | A |
| 11 | 11 | A(6) | B (3) | A(0.09) | B(4.0) | B(1.22) | A |
| 12 | 12 | A(6) | B (3) | B(0.15) | C(5.0) | B(1.13) | A |
| 13 | 13 | B (10) | B (4) | A(0.09) | C(5.1) | A(1.30) | B(2 Stripes) |
| 14 | 14 | B (12) | B (4) | A(0.07) | B(3.1) | B(1.21) | A |
| 15 | 15 | B (14) | B (4) | A(0.07) | B(3.0) | B(1.20) | A |
| 16 | 16 | A(4) | B (3) | B(0.12) | B(4.0) | A(1.31) | B(2 Stripes) |
| 17 | 17 | A(3) | B (3) | B(0.18) | B(4.1) | B(1.20) | B(2 Stripes) |
| 18 | 18 | B (10) | B (5) | B(0.15) | B(3.9) | B(1.21) | B(2 Stripes) |
| C.E. 1 | 19 | C(19) | B (5) | D(0.31) | C(5.0) | D(0.88) | D |
| C.E. 2 | 20 | D(21) | C(7) | B(0.18) | C(5.0) | C(0.95) | A |
| C.E. 3 | 21 | B (14) | D(9) | D(0.37) | D(7.1) | D(0.74) | D |
| C.E. 4 | 22 | B (14) | D(10) | C(0.24) | C(6.1) | D(0.78) | C(6 Stripes) |
| C.E. 5 | 23 | A(3) | D(12) | C(0.21) | C(6.0) | D(0.75) | D |
| C.E. 6 | 24 | B (10) | D(9) | C(0.31) | D(7.3) | D(0.63) | D |

In the Table, “C.E.” denotes “Comparative example”.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-166952, filed Sep. 13, 2019, which is hereby incorporated by reference herein in its entirety.

What is claimed is:

1. A toner comprising a toner particle including a binder resin, wherein in a temperature T (° C.)-storage elastic modulus G′ (Pa) curve obtained at a temperature rise rate of 2.0° C./min by measuring the toner with a rotating plate rheometer,
(i) a storage elastic modulus G′ (80° C.) at 80° C. is from 2.0×10³ Pa to 2.0×10⁵ Pa; and
(ii) a local minimum value of a change amount (dG′/dT) of a storage elastic modulus G′ in a range of 60° C. to 80° C. with respect to a temperature T is −1.0×10⁶ or less, and
when the temperature of the toner is raised from 25° C. to 120° C. at a temperature rise rate of 10° C./min, where a projected area of the toner at 80° C. is S₁ (μm²), a radius of the projected area of the toner at 80° C. is R₁ (μm), and a projected area of the toner at 120° C. is S₂ (μm²),
the S₁, R₁ and S₂ satisfy a following formula (1):
S₂/S₁×1/R₁≤0.22. (1)

2. The toner according to claim 1, wherein in the temperature T (° C.)-storage elastic modulus G′ (Pa) curve,
a storage elastic modulus G′ (120° C.) at 120° C. is from 2.0×10³ Pa to 2.0×10⁴ Pa.

3. The toner according to claim 1, wherein when the toner is extracted by Soxhlet extraction using tetrahydrofuran for 18 hours, the toner includes a tetrahydrofuran-insoluble matter, and
a storage elastic modulus G′ (120° C.) at 120° C. measured at a temperature rise rate of 2.0° C./min by measuring the tetrahydrofuran-insoluble matter with a rotating plate rheometer is from 1.0×10⁵ Pa to 1.0×10⁷ Pa.

4. The toner according to claim 1, wherein
where an amount of an ethyl acetate-insoluble matter of the toner, when the toner is extracted for 18 hours by Soxhlet extraction using ethyl acetate, is α (% by mass), and
an amount of a tetrahydrofuran-insoluble matter of the toner, when the toner is extracted for 18 hours by Soxhlet extraction using tetrahydrofuran, is β (% by mass),
the α and the β satisfy following formulas (2) and (3):
5.0≤≤β≤30.0 (2)
10.0≤(α-β)≤40.0. (3)

5. The toner according to claim 1, wherein the binder resin includes a hybrid resin having a vinyl polymer segment and an amorphous polyester segment.

6. The toner according to claim 5, wherein
the vinyl polymer segment has a structure in which at least one selected from the group consisting of an acrylic acid ester and a methacrylic acid ester is polymerized, and
a total amount of the structure in which at least one selected from the group consisting of an acrylic acid ester and a methacrylic acid ester is polymerized in the vinyl polymer segment is from 50% by mass to 98% by mass.

7. The toner according to claim 5, wherein the amount of the amorphous polyester segment in the hybrid resin is from 50% by mass to 98% by mass.

8. The toner according to claim 5, wherein the amorphous polyester segment has a structure crosslinked by at least one selected from the group consisting of a trihydric or higher polyhydric alcohol and a trivalent or higher polycarboxylic acid.

9. The toner according to claim 1, wherein
the toner particle includes a crystalline polyester,
the crystalline polyester is a polycondensation product of an alcohol component including an aliphatic diol and an acid component including an aliphatic dicarboxylic acid, and
when a carbon number of the aliphatic diol is C1, and a carbon number of the aliphatic dicarboxylic acid is C2, a sum of C1 and C2 is from 10 to 16.

10. The toner according to claim 1, wherein
in the differential scanning calorimeter (DSC) measurement of the toner, when
(i) the number of cold crystallization peaks in a range of from 40° C. to 120° C. at a time of lowering temperature is X, and
(ii) the number of endothermic peaks in a range of from 40° C. to 120° C. at a time of a second temperature rise is Y,
X and Y satisfy following formulas (7) and (8):
X≥1 (7)
Y≥X+1. (8)

11. The toner according to claim 1, wherein
the toner particle includes a crystalline polyester resin, and
in differential scanning calorimetry of the toner,
a temperature is raised from 25° C. to 120° C. at a rate of 1000° C./sec,
the temperature is held at 120° C. for 100 msec and then cooling is performed to 25° C. at a rate of 1000° C./sec, and then
the temperature is raised to 120° C. at a rate of 1000° C./sec, and
when a glass transition temperature at a first temperature rise is Tg1 (° C.), and a glass transition temperature at a second temperature rise is Tg2 (° C.),
following formulas (9) and (10) are satisfied:
65° C.≤Tg1≤85° C. (9)
7° C.≤Tg1-Tg2≤30° C. (10)

12. The toner according to claim 1, wherein
in the temperature T (° C.)-storage elastic modulus G′ (Pa) curve, a temperature at which the storage elastic modulus is 1.0×10³ Pa is T1 (° C.),
in a DSC curve obtained by differential scanning calorimetry of the toner, an endothermic peak exists in a range of from 30° C. to 120° C., and
when a peak temperature of a peak present on a lowest temperature side of the endothermic peak is T2 (° C.),
a following formula (11) is satisfied:
T1-T2≥40. (11)
